(19) United States
(12) Patent Application Publication
(10) Pub. No.: US 2025/0348661 A1
(43) Pub. Date: Nov. 13, 2025

(54) METHOD AND SYSTEM FOR COMBINATION FILLING OF SPREADSHEET ANALYTICAL FUNCTION OUTPUTS

(71) Applicant: Adaptam Inc., Palo Alto, CA (US)

(72) Inventors: Robert E. Dvorak, Portola Valley, CA (US); Yuriy Garin, San Carlos, CA (US); Alexey Verkhovskiy, Calgary (CA)

(73) Assignee: Adaptam Inc., Palo Alto, CA (US)

(21) Appl. No.: 19/200,549

(22) Filed: May 6, 2025

Related U.S. Application Data
(60) Provisional application No. 63/643,876, filed on May 7, 2024.

(51) Int. Cl. G06F 40/18

(52) U.S. Cl. CPC G06F 40/18

(57) ABSTRACT

The disclosed technology for applying a fill parameter to prebuilt spreadsheet table populating functions that fills otherwise not present field/range combinations of values in the table output. It adds a new capability to existing prebuilt spreadsheet functions and can be employed for future prebuilt functions. It works for all data types and for data from multiple cells within the spreadsheet or data not stored in a spreadsheet, including data not discretely defined. The technology disclosed can employ fill types determined by application default or by user specification.

### CROSS-REFERENCE

This application claims the benefit of U.S. Provisional Application No. 63/643,876 titled “Method and System for Combination Filling of Spreadsheet Analytical Function Outputs,” filed 7 May 2024 (Atty. Docket No. ADAP 1021-2), which is incorporated by reference herein.

### RELATED APPLICATIONS

This application is related to and incorporates by reference the following applications:

U.S. application Ser. No. 16/31,339 titled “Methods and Systems for Providing Selective Multi-Way Replication and Atomization of Cell Blocks and Other Elements in Spreadsheets and Presentations,” filed 10 Jul. 2018, now U.S. Pat. No. 11,182,548, issued 23 Nov. 2021 (Atty. Docket No. ADAP 1000-2), which claims the benefit of U.S. Provisional Application No. 62/530,835, filed 10 Jul. 2017 (Atty. Docket No. ADAP 1000-1).

U.S. application Ser. No. 16/31,379 titled “Methods and Systems for Connecting a Spreadsheet to External Data Sources with Formulaic Specification of Data Retrieval,” filed 10 Jul. 2018, now U.S. Pat. No. 11,354,494, issued 7 Jun. 2022 (Atty. Docket No. ADAP 1001-2), which claims the benefit of U.S. Provisional Application No. 62/530,786, filed 10 Jul. 2017 (Atty. Docket No. ADAP 1001-1).

U.S. application Ser. No. 16/31,759 titled, “Methods and Systems for Connecting a Spreadsheet to External Data Sources with Temporal Replication of Cell Blocks,” filed 10 Jul. 2018, now U.S. Pat. No. 11,17,165, issued 25 May 2021 (Atty. Docket No. ADAP 1002-2), which claims the benefit of U.S. Provisional Patent Application No. 62/530,794, filed 10 Jul. 2017 (Atty. Docket No. ADAP 1002-1).

U.S. application Ser. No. 16/191,402 titled, “Methods and Systems for Connecting a Spreadsheet to External Data Sources with Ordered Formulaic Specification of Data Retrieved,” filed 14 Nov. 2018, now U.S. Pat. No. 11,36,929, issued 15 Jun. 2021 (Atty. Docket No. ADAP 1003-2), which claims the benefit of U.S. Provisional Patent Application No. 62/586,719, filed on Nov. 15, 2017 (Atty Docket ADAP 1003-1).

U.S. application Ser. No. 17/359,430 titled, “Methods and Systems for Constructing a Complex Formula in a Spreadsheet Cell,” filed 25 Jun. 2021, now U.S. Pat. No. 11,836,444, issued 5 Dec. 2023 (Atty Docket ADAP 1004-2), which claims the benefit of U.S. Provisional Patent Application No. 63/044,990, filed 26 Jun. 2020 (Atty Docket No. ADAP 1004-1).

U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023 (Atty Docket No. ADAP 1005-2), which claims the benefit of U.S. Provisional Patent Application No. 63/044,989, filed 26 Jun. 2020 (Atty Docket No. ADAP 1005-1).

U.S. application Ser. No. 17/384,404 titled “Method and System for Improved Spreadsheet Charts,” filed 23 Jul. 2021, now U.S. Pat. No. 12,058,445, issued 6 Aug. 2024 (Atty Docket No. ADAP 1006-2), which claims the benefit of U.S. Provisional Patent Application No. 63/055,581, filed 23 Jul. 2020 (Atty Docket No. ADAP 1006-1).

U.S. application Ser. No. 17/374,898 titled “Method and System for Improved Spreadsheet Analytical Functioning,” filed 13 Jul. 2021, now U.S. Pat. No. 11,694,23, issued 4 Jul. 2023 (Atty Docket No. ADAP 1007-2), which claims the benefit of U.S. Provisional Patent Application No. 63/051,280, filed 13 Jul. 2020 (Atty Docket No. ADAP 1007-1).

U.S. application Ser. No. 17/374,901 titled “Method and System for Improved Ordering of Output from Spreadsheet Analytical Functions,” filed 13 Jul. 2021, now U.S. Pat. No. 11,972,204, issued 30 Apr. 2024 (Atty Docket No. ADAP 1008-2), which claims the benefit of U.S. Provisional Patent Application No. 63/051,283, filed 13 Jul. 2020 (Atty Docket No. ADAP 1008-1).

U.S. application Ser. No. 17/752,814 titled “Method and System for Spreadsheet Error Identification and Avoidance,” filed 24 May 2022, now U.S. Pat. No. 11,977,835, issued 7 May 2024 (Atty Docket No. ADAP 1009-2) which claims the benefit of U.S. Provisional Patent Application No. 63/192,475, filed 24 May 2021 (Atty Docket No. ADAP 1009-1).

U.S. application Ser. No. 17/903,934 titled “Method and System for Improved 2d Ordering of Output from Spreadsheet Analytical Functions,” filed 6 Sep. 2022, now U.S. U.S. Pat. No. 12,050,859, issued 30 Jul. 2024 (Atty Docket No. ADAP 1010-2) which claims the benefit of U.S. Provisional Patent Application No. 63/240,828, filed 3 Sep. 2021 (Atty Docket No. ADAP 1010-1).

U.S. application Ser. No. 17/988,641 titled “Methods and Systems for Sorting Spreadsheet Cells with Formulas,” filed 16 Nov. 2022 (Atty Docket No. ADAP 1011-2) which claims the benefit of U.S. Provisional Patent Application No. 63/280,590, filed 17 Nov. 2021 (Atty Docket No. ADAP 1011-1).

U.S. application Ser. No. 18/074,301 titled “Method and System for Improved Visualization of Charts in Spreadsheets,” filed 2 Dec. 2022 (Atty Docket No. ADAP 1012-2) which claims the benefit of U.S. Provisional Patent Application No. 63/25,945, filed 3 Dec. 2021 (Atty Docket No. ADAP 1012-1).

U.S. application Ser. No. 18/142,560 titled “Methods and Systems for Spreadsheet Function and Flex Copy-Paste Control of Formatting and Use of Selection List Panels,” filed 2 May 2022, now U.S. Pat. No. 12,169,687, issued 17 Dec. 2024 (Atty Docket No. ADAP 1013-2) which claims the benefit of U.S. Provisional Application No. 63/337,576, filed 2 May 2022 (Atty Docket No. ADAP 1013-1).

U.S. application Ser. No. 18/142,557 titled “Methods and Systems for Bucketing Values in Spreadsheet Functions,” filed 2 May 2023 (Atty Docket No. ADAP 1014-2) which claims the benefit of U.S. Provisional Application No. 63/337,572, filed 2 May 2022 (Atty Docket No. ADAP 1014-1).

U.S. application Ser. No. 18/542,510 titled “Methods and Systems for Flexibly Linking Spreadsheet Cell Movements and Formulas,” filed 15 Dec. 2023 Atty Docket No. ADAP 1015-2) which claims the benefit of U.S. Provisional Application No. 63/433,408, filed 16 Dec. 2022 (Atty Docket No. ADAP 1015-1).

U.S. application Ser. No. 18/765,168, filed 5 Jul. 2024 which claims the benefit of U.S. Provisional Application No. 63/525,138, titled “Methods and Systems for Specifying and Using in Spreadsheet Cell Formulas Joins Between Data Sets,” filed 5 Jul. 2023 (Atty Docket No. ADAP 1016-1).

U.S. application Ser. No. 18/777,446 titled “Methods and Systems for Specifying and Using Joins Between Data Sets in A Spreadsheet Data Visualizer,” filed 18 Jul. 2024 which claims the benefit of U.S. Provisional Application No. 63/529,135, filed 5 Jul. 2023 (Atty Docket No. ADAP 1017-1).

U.S. application Ser. No. 19/031,145 titled “Methods and Systems for a Family of Dual Entry Spreadsheet Functions, Improved Spreadsheet Validations, and Partial Locking of Spreadsheet Functions and Cell Capabilities,” filed 17 Jan. 2025 which claims the benefit of U.S. Provisional Application No. 63/622,515, filed 18 Jan. 2024 (Atty Docket No. ADAP 1019-1).

U.S. application Ser. No. 18/586,370, titled “Method and System For Repeat 2d Ordering of Output From Spreadsheet Analytical Functions,” filed 23 Feb. 2024 (Atty Docket No. ADAP 1020-1) which is a continuation-in-part of application Ser. No. 17/903,934, titled “Method and System For Improved 2d Ordering of Output From Spreadsheet Analytical Functions,” filed 6 Sep. 2022 (Atty Docket No. ADAP 1010-2) which claims the benefit of U.S. Provisional Application No. 63/240,828, filed 3 Sep. 2021 (Atty Docket No. ADAP 1010-1.)

### BACKGROUND

Our previously described prebuilt spreadsheet function technologies make it incredibly easy to solve one-dimensional (i.e., column or row output) and two-dimensional (i.e., column and row combined output) spreadsheet problems requiring repetitive evaluations (i.e., programming loops) and tailored presentation of the outcomes. By prebuilt spreadsheet function we mean a built-in predefined formula supplied with the spreadsheet or an installed spreadsheet add-in. The prebuilt spreadsheet function is used in a spreadsheet cell that has a specified name that is used to start its formula that is followed by an opening parentheses followed by the arguments, in a particular order, and ended by a closing parentheses. It is outstanding for problems with results involving ordering of outcomes (e.g., largest to smallest, first to last) as part of answering user questions solving problems employing a broad set of functions and algebraic formulas. The technologies described include filling single column of date or integer output fields for missing increments of one (day or integer) date or integer progressions. However, there are situations were with nested headings where the user wants to repetitively fill an output field/range for each value of another output field/range of the function. And where the user would also like to fill that second field/range as well while filling the missing values for the first field repetitions. Additionally, there are situations where there are more than two nested fields/ranges that the user wants to repetitively fill for each value of the filled field/range combinations. Accordingly, an opportunity arises to add feature/functionality to prebuilt spreadsheet functions that generate and organize one-dimensional and two-dimensional data sets and data set calculations to repetitively fill nested outputs of one or more output field/range for each value of another output field/range. An opportunity also arises to move the filling of missing values beyond dates and integers incremented by one to specified lists and sets of existing values (all or unique) replicated for each related field/range value. An opportunity also arises to apply the specified list and sets of existing values (all or unique) replicated for each related field/range value to real and text fields/ranges. And this opportunity exists for functions employing data fields/ranges that are sourced from in spreadsheet cell data or non-spreadsheet cell data from external data.

An opportunity also arises to apply this expanded feature/functionality of repeating filling and employing it for a broader set of field/range data types (e.g., reals, text, and Booleans) to existing spreadsheet functions that transform existing spreadsheet cell data sets or data tables such as the FILTER, SORT, and SORTBY functions.

### SUMMARY

The disclosed technology creates fill parameters that fill otherwise not present field/range combinations of values in the table output of prebuilt spreadsheet functions which populate a table of values (e.g., our functions described in U.S. application Ser. No. 16/191,402 titled, “Methods and Systems for Connecting a Spreadsheet to External Data Sources with Ordered Formulaic Specification of Data Retrieved,” filed 14 Nov. 2018, now U.S. Pat. No. 11,36,929, issued 15 Jun. 2021, U.S. application Ser. No. 17/374,901 titled “Method and System for Improved Ordering of Output from Spreadsheet Analytical Functions”, filed 13 Jul. 2021, U.S. application Ser. No. 17/903,934 titled “Method and System for Improved 2d Ordering of Output from Spreadsheet Analytical Functions”, filed 6 Sep. 2022, and U.S. application Ser. No. 18/586,370 titled “Method and System For Repeat 2d Ordering of Output From Spreadsheet Analytical Functions”, FILTER, SORT, SORTBY and TRANSPOSE). Those embodiments fill repetitive combinations of two or more data fields/ranges with or without other related fields/ranges. Embodiments support different fill sets of values determined by default application specification or user specification. Examples of the fill sets supported by embodiments include a set of all data field/range values, all the unique data field/range values, ranges of dates or integers with automatic increments of one, a set of values user specified, and any or all of these specified by reference to a cell holding the values or formula defining the values. Embodiments work for filling data fields/ranges that are integers, reals, dates, text, and Booleans. Embodiments of our technology support different ways of specifying the fill parameter including modifying existing arguments within the functions to adding one or more additional arguments to the functions. Embodiments support adding the fill values without otherwise disrupting the ordering and in some situations the constraints/filters applied by the spreadsheet functions.

For all of our embodiments the data can be sourced from multiple cells within the spreadsheet or a broad spectrum of numeric, date, Boolean, and text data not stored in a spreadsheet, including data not discretely defined. The technology disclosed can use as inputs either cell ranges or Non-Spreadsheet Cell (NSC) data formulas.

Particular aspects of the technology disclosed are described in the claims, specification, and drawings.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIGS. 1A and 1B examples a non-combination (single fill) prior art filled date field/range versus the same functional formula unfilled.

FIG. 2 illustratively examples the steps automatically executed to deliver the filling in FIG. 1B.

FIGS. 3A and 3B examples a non-combination (single fill) prior art filled date field/range versus the same functional formula unfilled for a nested situation.

FIG. 4 illustratively examples the steps automatically executed to deliver the filling in FIG. 3B.

FIGS. 5A and 5B examples a combination filled spreadsheet table generator functional formula employing the default fill sets versus the same functional formula unfilled.

FIG. 6 illustratively examples the steps automatically executed to deliver the combination filling in FIG. 5B.

FIGS. 7A and 7B examples a combination filled spreadsheet table generator functional formula employing one user specified range fill set and one default fill set versus the same functional formula unfilled.

FIG. 8 illustratively examples the steps automatically executed to deliver the combination filling in FIG. 7B.

FIGS. 9A and 9B examples a combination filled spreadsheet table generator functional formula where there is another output field/range not included in the fill parameter versus the same functional formula unfilled.

FIGS. 10 and 11 illustratively examples the steps automatically executed to deliver the combination filling in FIG. 9B.

FIGS. 12A and 12B examples a combination filled spreadsheet table generator functional formula where there is another output of an evaluated SUM formula not included in the fill parameter versus the same functional formula unfilled.

FIGS. 13 and 14 illustratively examples the steps automatically executed to deliver the combination filling in FIG. 12B.

FIGS. 15A and 15B examples a combination filled spreadsheet table generator functional formula employing a fill parameter with a repetitive pair syntax versus the same functional formula unfilled.

FIG. 16 illustratively examples, in abbreviated form, the steps automatically executed to deliver the combination filling in FIG. 15B.

FIGS. 17A and 17B examples a combination filled spreadsheet table generator functional formula employing a fill parameter with a repetitive pair syntax including a range fill set and a default fill set versus the same functional formula unfilled.

FIG. 18A examples an unfilled spreadsheet table generator functional formula used for comparison with the results in FIGS. 18B, 19A, and 19B.

FIG. 18B examples a combination filled spreadsheet table generator functional formula where there is another output of an evaluated SUM formula with both text and integer fields/ranges used in the fill parameter employing ‘!ALL’ fill sets.

FIG. 19A examples a combination filled spreadsheet table generator functional formula with an integer fill set employing a range and a text fill set employing an ‘!ALL’ fill set and where there is another output of an evaluated SUM formula.

FIG. 19B examples a combination filled spreadsheet table generator functional formula with an integer fill set employing a list and a text fill set employing an ‘!ALL’ fill set and where there is another output of an evaluated SUM formula.

FIGS. 20A and 20B examples a different combination fill FILL parameter location where the fill parameter is added to an existing field/range argument of the spreadsheet prebuilt functional formula (not a new optional argument added to the function).

FIG. 21 illustratively examples, in abbreviated form, the steps automatically executed to deliver the combination filling in FIG. 20B.

FIG. 22A and FIG. 22B examples using the combination fill FILL parameter (as a prebuilt function) located within an existing argument of the prebuilt spreadsheet function (‘WRITE_CALC_V’) employing a text list fill set and a text ‘!ALL’ fill set.

FIGS. 23A and 23B examples a combination filled spreadsheet table generator functional formula employing a fill parameter with a fill set argument populated by a cell reference to cell containing our LIST function.

FIGS. 24A and 24B examples a combination filled spreadsheet table generator functional formula employing a fill parameter with a default all unique real data type fill set.

FIGS. 25A, 25B and 25C examples the workings of a spreadsheet table generator functional formula, with and without a constraint/filter, and where that constraint/filter constrains/filters the combination fill values.

FIGS. 26A and 26B examples the results two double combination fills versus one triple combination fill involving the same three fields/ranges in our technology.

FIGS. 27A and 27B illustratively example, in abbreviated form, the steps automatically executed to deliver the two combination fills in FIG. 26A.

FIG. 28 illustratively examples, in abbreviated form, the steps automatically executed to deliver the triple combination fills in FIG. 26B.

FIGS. 29A, 29B, and 30 examples our technology supporting a combination fill of fields/ranges that are not the first nor the last fields output by the prebuilt spreadsheet function.

FIGS. 31A, 31B, and 32 examples our technology comparing the middle join of FIG. 29B (repeated as FIG. 31A for ease of comparison, although with a different fill parameter syntax) to a triple combination fill starting with the same two fill fields/ranges but then adding an additional combination fill field/range.

FIGS. 33A, 33B, and 34 example in our technology a triple combination fill of a ‘WRITE_CALC_V’ function executing an algebraic formula.

FIGS. 35A, 35B, and 36 example a triple combination fill of a ‘WRITE_V’ function employing data from non-spreadsheet cell or spreadsheet cell sources (like any of our other example) creating a column order of the data that is then row sorted by the spreadsheet prebuilt function.

FIGS. 37A, 37B, 38, and 39 examples two separate double combination fills within a ‘WRITE_CALC_2D’ function employing our technology.

FIGS. 40A, 40B, and 41 examples a triple combination fill of a ‘FILTER’ function with our technology.

FIGS. 42A and 42B examples a triple combination fill of a ‘FILTER’ function like that in FIG. 40B except using our formulaic data field names and our LIST function and employing a different fill parameter location and syntax.

FIGS. 43A and 43B examples a combination filled spreadsheet table generator functional formula employing one user specified list fill set and one range fill set versus the same functional formula unfilled.

FIG. 44 illustratively examples the steps automatically executed to deliver the combination filling in FIG. 43B.

FIGS. 45A, 45B, 46, and 47 examples a triple combination fill of a ‘WRITE_V’ function employing fill field/ranges of data types Boolean, integer and real.

FIGS. 48A, 48B, 49, and 50 examples a combination fill of a ‘SORTBY’ function using our technology.

FIGS. 51A and 51B conceptually examples the double combination fill cross join and examples of fill set types in our technology.

FIGS. 52A and 52B conceptually examples the triple combination fill cross join and examples of fill set types in our technology.

FIGS. 53A and 53B conceptually examples two of the many types of non-spreadsheet cell external data employed by our technology.

FIGS. 54A and 54B conceptually examples two of the many types of spreadsheet cell data employed by our technology.

FIG. 55 depicts an example computer system that can be used to implement aspects of the technology disclosed.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows.

When spreadsheet applications were first created, they electronically emulated tabular paper spreadsheets. More recently, Microsoft Excel, Google Sheets, Apple Numbers, and others have dramatically increased the breadth of capabilities and usefulness of spreadsheets. Spreadsheet applications now access data across a wide variety of sources including relational, structured, and semi-structured, open data protocol (OData), Web and Hadoop among others; and these applications manipulate data-such as in pivot tables and via Microsoft PowerPivot.

Spreadsheet providers like Microsoft Excel, Google Sheets, Apple Numbers, and Adaptam cater to the specialized needs of users through many mechanisms including vast numbers of spreadsheet functions (e.g., built in predefined formulas including SUM, COUNT and MIN). Microsoft Excel and Google Sheets includes more than four hundred built-in (prebuilt—delivered with the spreadsheet) functions. These built-in functions make operations desired by users dramatically simpler and are used by virtually every user.

The formulaically defined Non-Spreadsheet Cell (NSC) data variables and related technologies disclosed in “Methods and Systems for Connecting a Spreadsheet to External Data Sources with Formulaic Specification of Data Retrieval” filed previously, allow users to work with all types of numeric and text external data sets much larger and more complex than can currently fit in traditional spreadsheets. This external data connection creates the foundation for users to automate spreadsheet work without the use of embedded programming languages or special prebuilt data feeds, taking spreadsheets from a tool users employ to conduct one off or routine analytics to a real-time competitor of systems that automate repetitive activities.

The disclosed technology allows users to add repetitive (e.g., cross fill) data fill feature/functionality to spreadsheet functions in order to allow them to create outputs not previously possible from those functions. It is applicable to spreadsheet functions that generate table outputs (e.g., our WRITE_V, WRITE_CALC_H, WRITE_CALC_2D, and WRITE_CALC_2D_REPEAT functions) or transform existing data sets (e.g., FILTER, SORT, or SORTBY functions) to output multiple row and column tabular outputs. Our new technology makes it easy to add an argument or arguments to a functional formula to repetitively fill combinations of values for fields/ranges containing each data type. Those fill sets can be specified in many different manners set automatically by our spreadsheet application or manually specified by the user.

### PRIOR ART

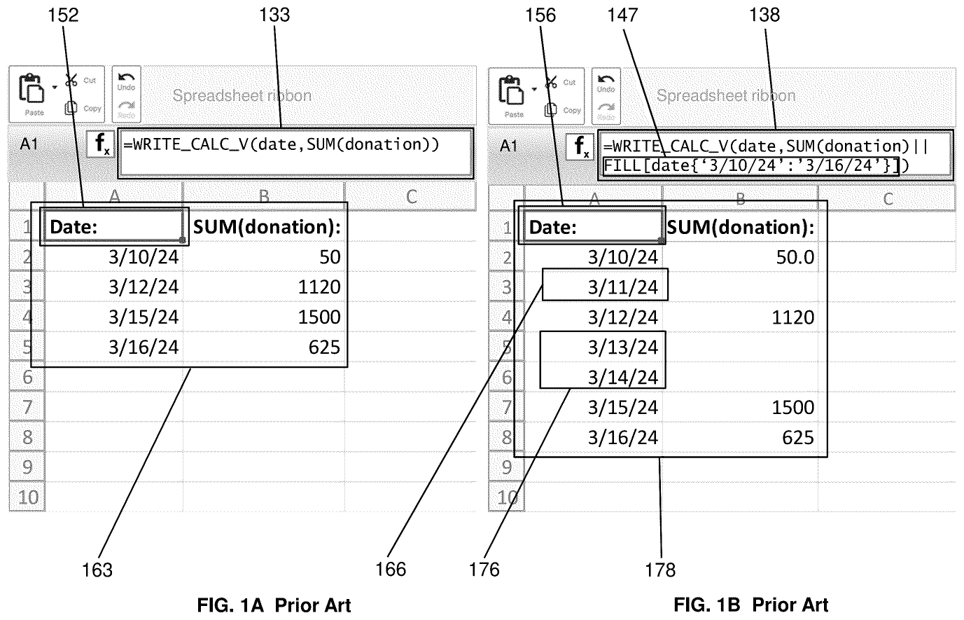

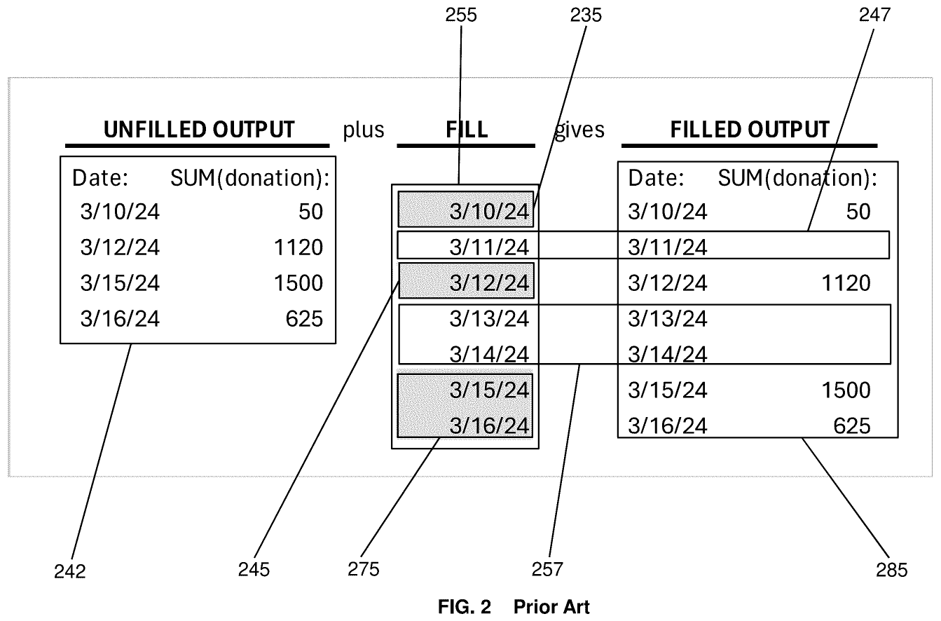

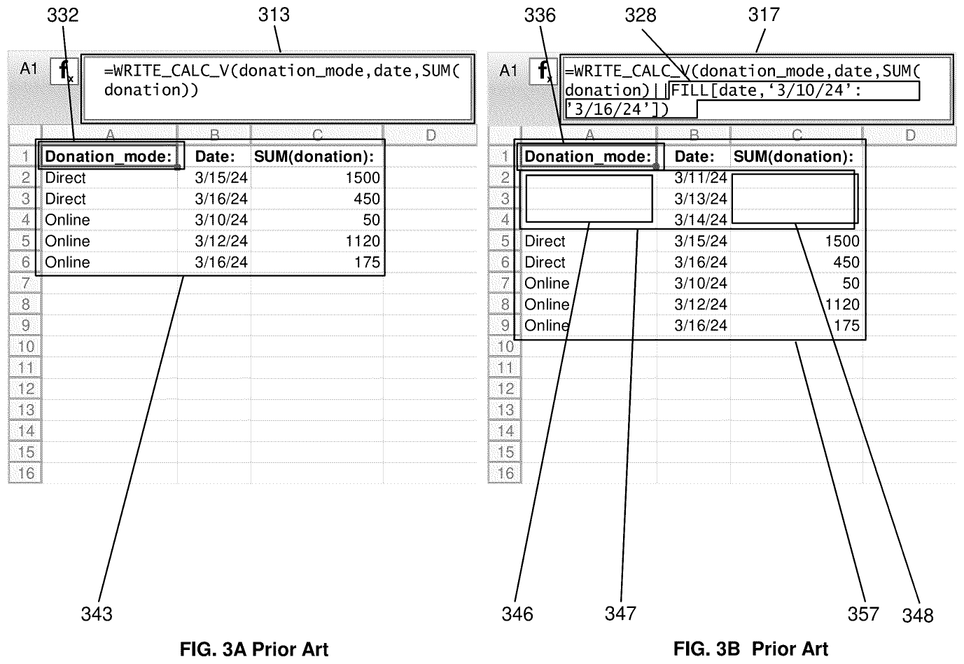

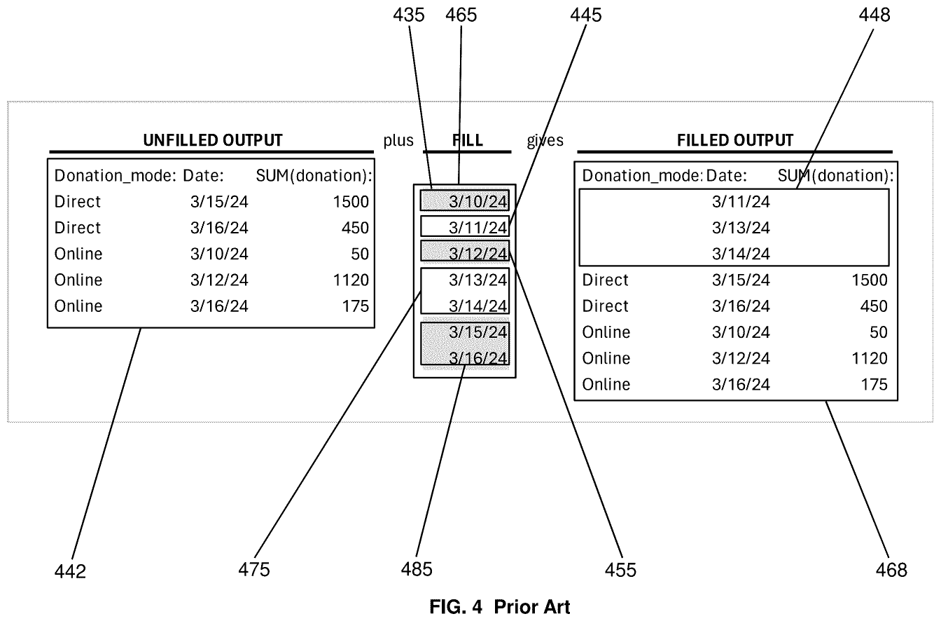

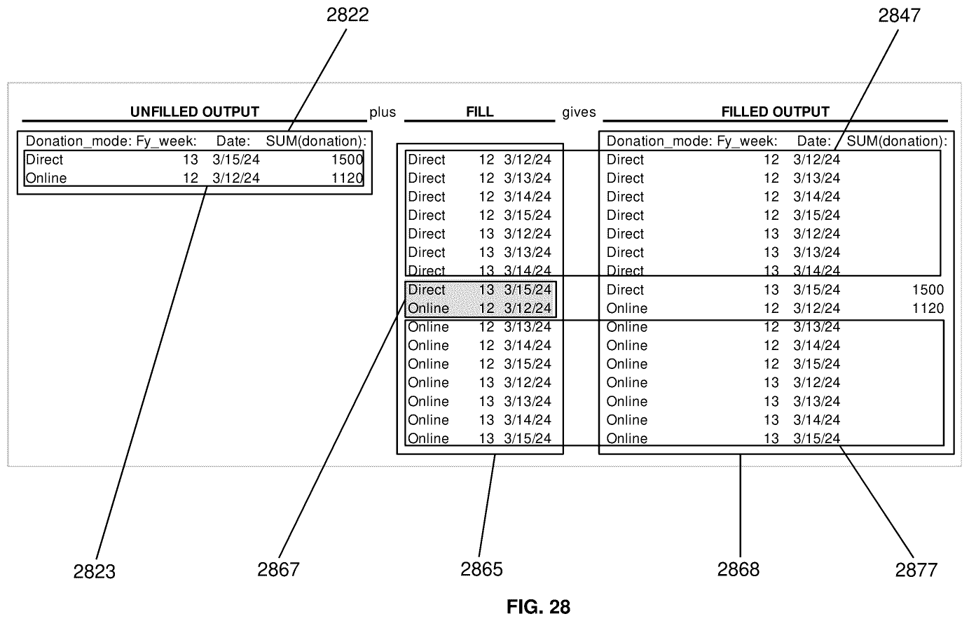

Only the Adaptam spreadsheet has prebuilt functions that fill values generated by the function. Our U.S. application Ser. No. 17/903,934 titled “Method and System for Improved 2d Ordering of Output from Spreadsheet Analytical Functions,” filed 6 Sep. 2022 introduced table generating functions doing single data field/range filling of date and integer ranges as exampled in FIG. 28 2843 of the '934 application and exampled here in FIG. 1B (filled) versus FIG. 1A (unfilled). Where the table generator function formula 133 in FIG. 1A in cell ‘A1’ 152 generates the unfilled output 163, while the addition of the optional fill argument 147 in the table generator function formula 138 in FIG. 1B in cell ‘A1’ 156 generates the filled output 178. This adds the filled date values 166 and 176 which were otherwise missing from the unfilled values. The fill was set by the date range ‘3/10/2024’ to ‘3/16/2024’ 147 automatically filling each of the dates in the range. This capability works very well for a single date or integer heading for a functional output and illustratively uses a process laid out in FIG. 2 where the unfilled output 242 is combined with the fill 255 adding only those values not present (247 and 257) in the unfilled output to generate the filled output 285. In the process it eliminates the fill values (235, 245, and 275) already represented in the unfilled output. However, in a nested field/range output situation where the user wants nested replication of the filling, the current technology (without our new filling technology) does not deliver that as exampled in FIG. 3A through FIG. 4.

The table generator function formula 313 in FIG. 3A in cell ‘A1’ 332 generates the unfilled output 343, while the addition of the optional fill argument 328 in the table generator function formula 317 in cell ‘A1’ 336 generates the filled output 357. This adds the filled date values 347 which were otherwise missing from the unfilled values. The filling was set by the date range ‘3/10/2024’ to ‘3/16/2024’ 328 automatically filling each of the dates in the range. As you can see this process fills the dates but does not fill either of the other two fields/ranges (346 and 348) output by the table generator function as illustratively laid out in FIG. 4 where the unfilled output 442 is combined with the fill 465 adding only those values not present (445 and 475 to 448) in the unfilled output to generate the filled output 468. In the process it eliminates the fill values (435, 455, and 485) already represented in the unfilled output. And this ‘WRITE_CALC_V’ function sorts the row output first alphabetically A to Z by the first column ‘Donation_mode’ (with blanks first), then by ascending dates in the second column ‘Date:’, and then ascending values in the third column ‘SUM(donation:’. Therefore, a different solution is required for situations where the user wants nested repeating filling as we will now example for our new technology.

### Table Generator Function Nested Fills

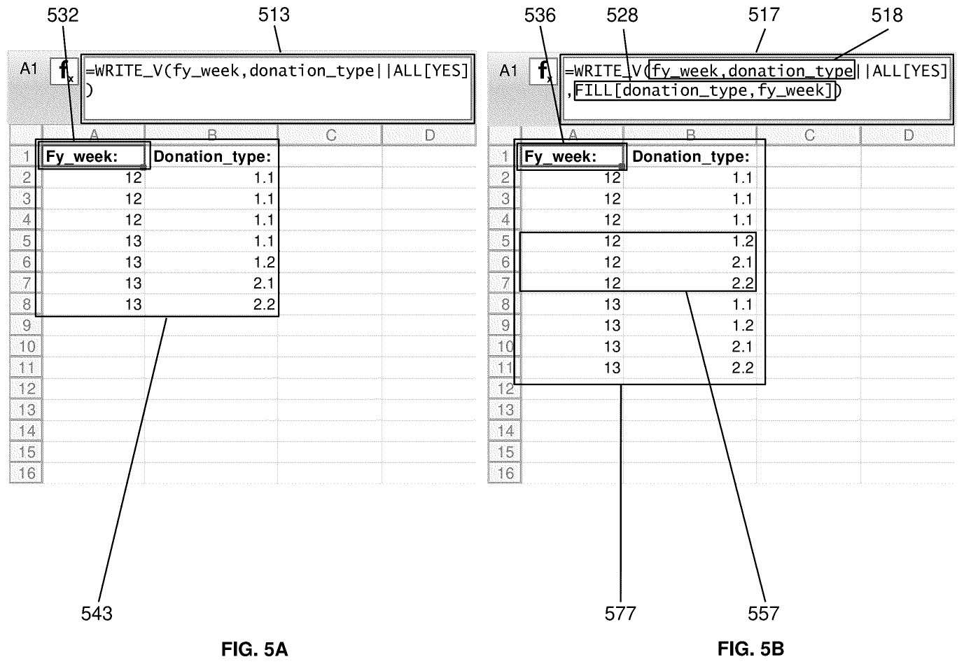

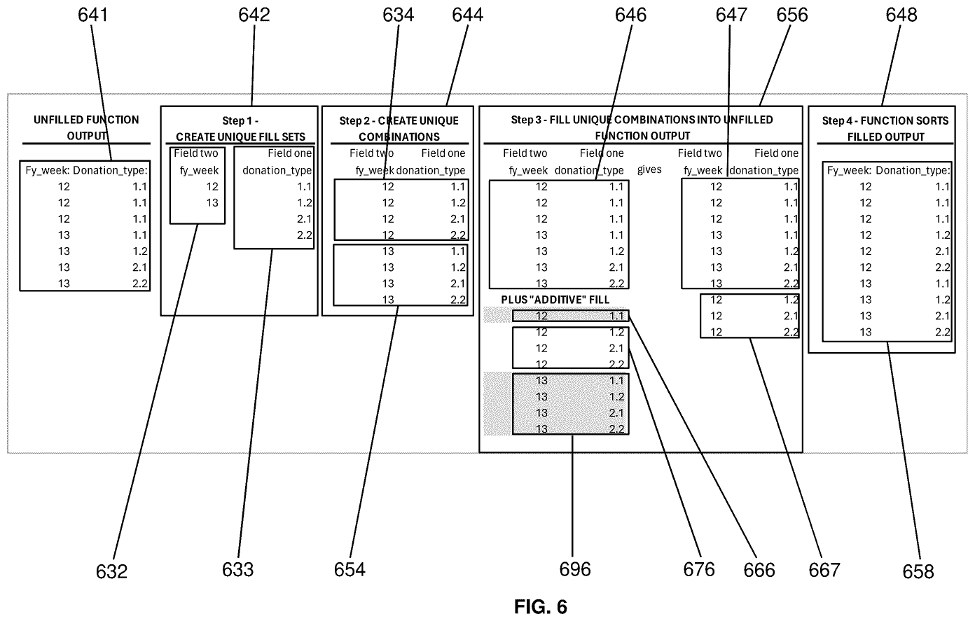

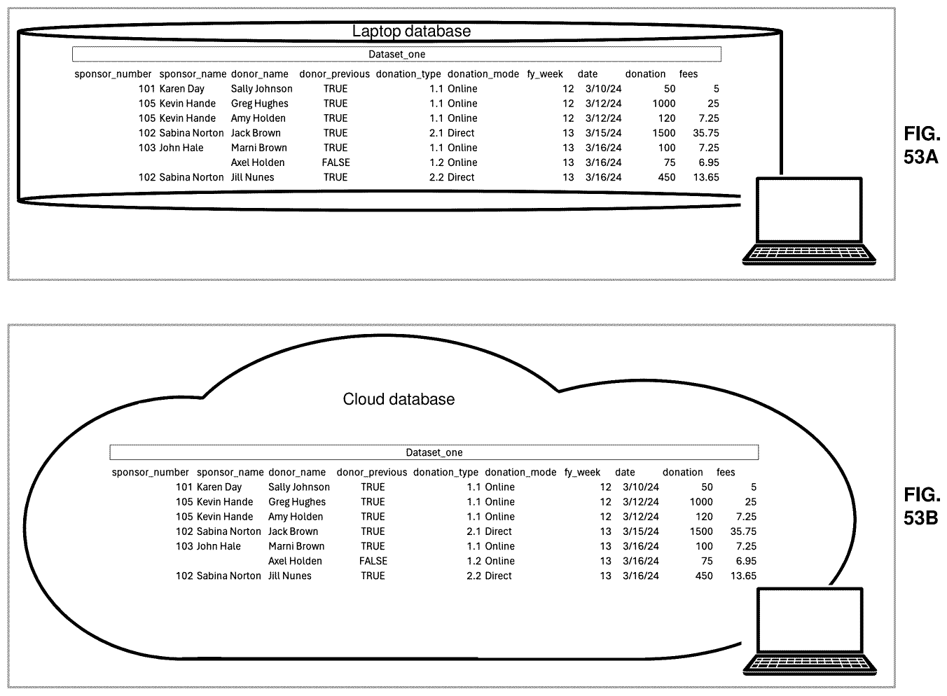

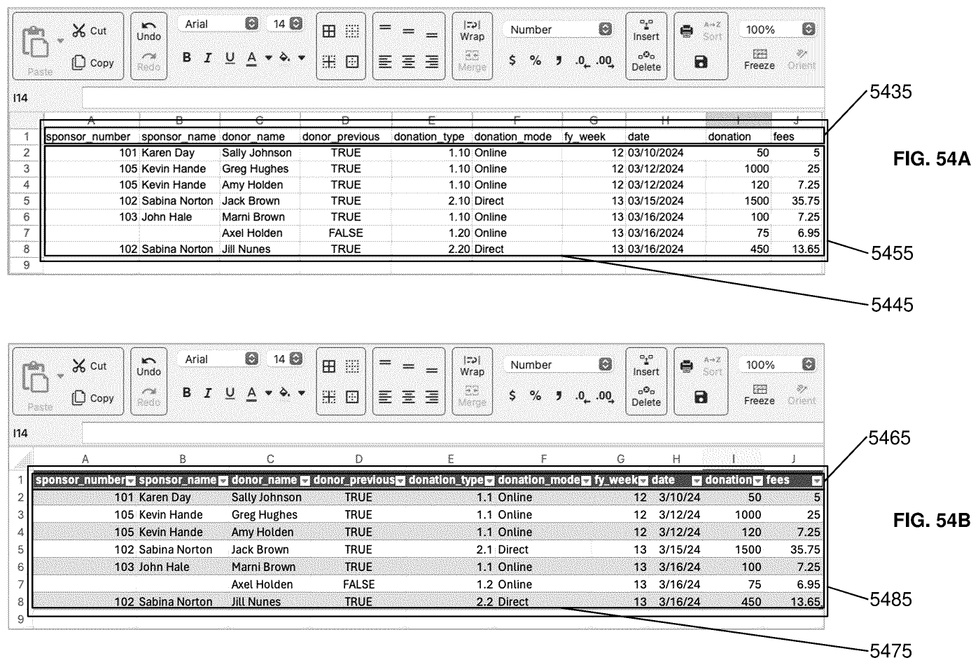

FIG. 5A through FIG. 6 examples one embodiment of our nested combination of fills employed for one of our spreadsheet table generator functions (e.g., our WRITE_V, WRITE_CALC_H, WRITE_CALC_2D, and WRITE_CALC_2D_REPEAT functions) compared to the unfilled version of the same formula. The table generator function employs data that can be sourced from non-spreadsheet cell external data (e.g., FIG. 53A and FIG. 53B) or spreadsheet cells (e.g., FIG. 54A and FIG. 54B). For the spreadsheet cell sourced data it can employ our formulaic data fields or cell range naming of the parts of the data sets. For example, in the FIG. 54A the named formulaic data fields uses the range ‘A1’ through ‘J8’ 5455 with the headings in cells ‘A1’ through ‘J1’ 5435 being the formulaic data field names and the values in cells ‘A2’ through ‘J8’ 5445 being the data. Similarly, in the FIG. 54B the named formulaic data fields uses the table in ‘A1’ through ‘J8’ 5485 with the headings in cells ‘A1’ through ‘J1’ 5465 being the formulaic data field names and the values in cells ‘A2’ through ‘J8’ 5475 being the data. Our technology also supports cell range naming which in FIG. 54A uses each of the columns in the range ‘A2’ through ‘J8’ 5445 as the ranges (excluding the table headings 5435) and in FIG. 54B uses each of the columns in the range ‘A2’ through ‘J8’ 5475 as the ranges (excluding the table headings 5465). All of our table generator examples herein will employ any of these same cell or non-spreadsheet cell data sets unless otherwise identified. We do this to keep the examples simple and not have to discuss all the data options for each example and each embodiment.

FIG. 5A examples the unfilled ‘WRITE_V’ functional formula 513 for the cell ‘A1’ 532 which populates the cells ‘A1’ through ‘B8’ 543. However, the user wants a complete set of ‘donation_type’ values populated from each ‘fy_week’ and therefore in this embodiment of our technology adds an optional fill parameter argument ‘FILL[donation_type,fy_week]’ 528 to the ‘WRITE_V’ functional formula 517 in cell ‘A1’ 536 which populates the cells ‘A1’ through ‘B11’ 577. This addition has resulted in the filling of the ‘Fy_week:’ and ‘Donation_type:’ values 557 which were not present in the unfilled values 543 in FIG. 5A. The result is that both of the ‘Fy_week:’ values ‘12’ and ‘13’ have the complete set of ‘Donation_type:’ fill values ‘1.1’. ‘1.2’, 2.1’, and ‘2.2’. Our technology delivered filled combination sets having all the ‘donation_type’ values for each of the ‘fy_week’ values as per the fill parameter ‘FILL[donation_type,fy_week] as illustratively exampled in FIG. 6 (which illustratively exampled what is done without necessarily showing exactly how our application achieves the same outcome).

Note in FIG. 5B the fill parameter 528 is what we have called in previous fillings a named argument, or a keyword named argument so that it can be added in any order within the function arguments or an argument group. However, our fill parameter can also be added to a function as a set of arguments within the specified order of arguments for that function. In FIG. 5B the fill parameter 528 has also made the first data field in the FILL argument the last field that is filled in the functional formula and the second data field in the FILL argument a field preceding the first field in the functional formula (e.g., ‘donation_type’ comes after ‘fy_week’ in the ‘WRITE_V’ functional formula 518 but ‘donation_type’ comes before ‘fy_week’ in the functional formula FILL argument 528. However, our technology supports any order of the data field/ranges within the FILL argument or arguments, so the order of the fields in the FILL argument could be switched.

### Default Fill

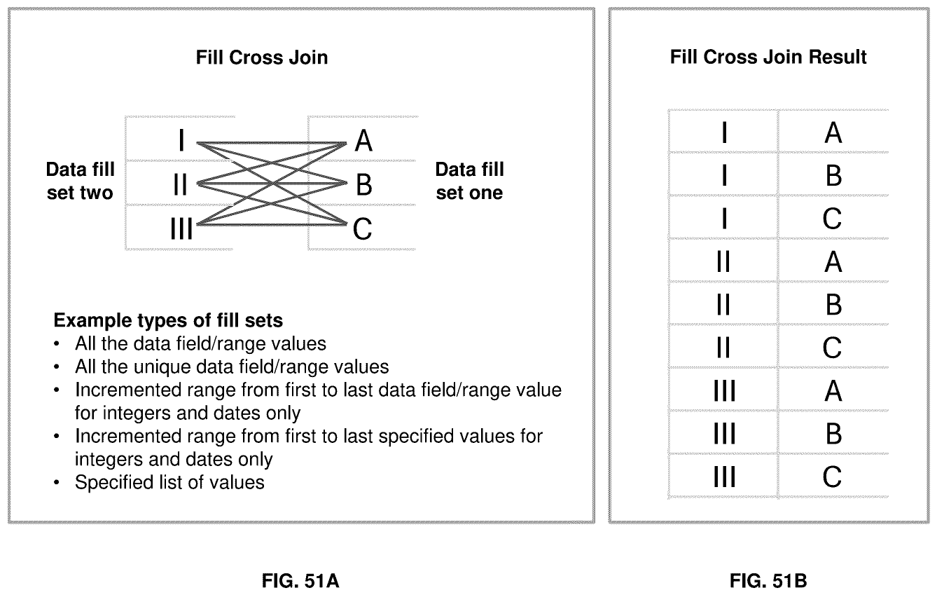

FIG. 5B examples an embodiment of our technology with a default setting for the fills that starts with the unfilled results as exampled in 641 in FIG. 6 from which ‘Step 1’ 642 creates the two unique lists of the fields/ranges 632 and 633 involved in filling. ‘Step 2’ 644 then creates cross joined combinations of those unique lists of fields/ranges as exampled in the combinations for ‘fy_week’ ‘12’ 634 and ‘fy_week’ ‘13’ 654 in this example. The cross join works as illustratively exampled in FIG. 51A giving the illustrative result in FIG. 51B. As FIG. 51A examples there are many different ways in our technology to create the fill sets with FIG. 5B and FIG. 6 exampling the ‘All the unique data field/range values’ approach. ‘Step 3’ 656 then adds any otherwise not present values (676) from the cross joins (666, 676, and 696) eliminating any value already present (666 and 696) in the unfilled values (646) as shown in 647 (unfilled) and 667 (fill). Then the normal sorting of the results by the table generator function kicks in as exampled in ‘Step 4’ 648 to give the result 658 returned to cells ‘A1’ through ‘B11’ 577 in FIG. 5B. This example employed a fill parameter syntax where the user specifies the fields/ranges to be combination filled and if they only enter the field/range gets an all-unique cross join combination fill set (default). They have the option to add a non-default fill set as will be exampled later. Our technology also supports many different fill parameter syntaxes and locations as will be exampled later.

### Range Fill (Date)

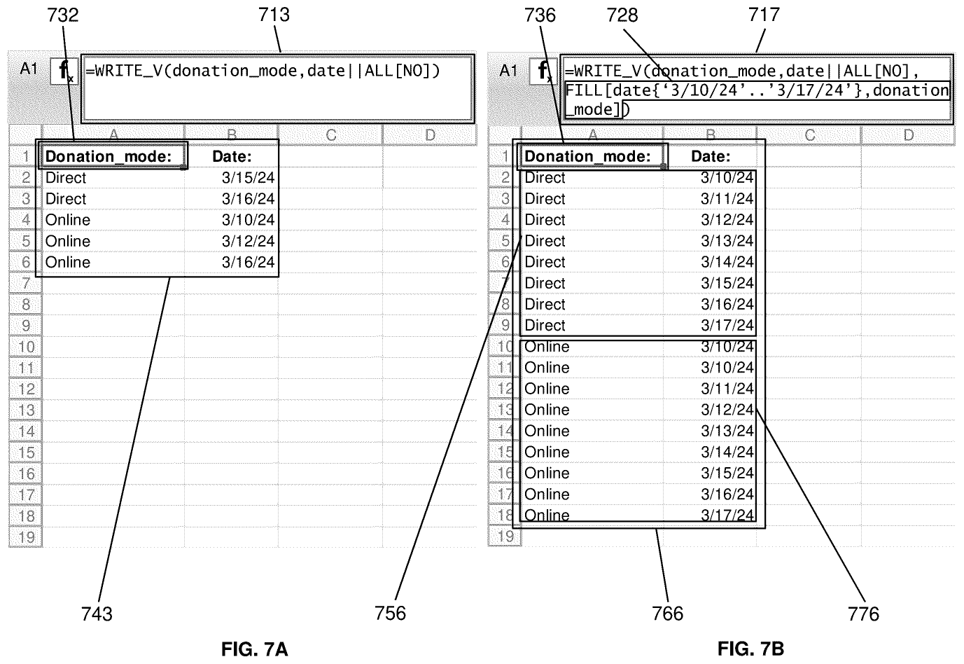

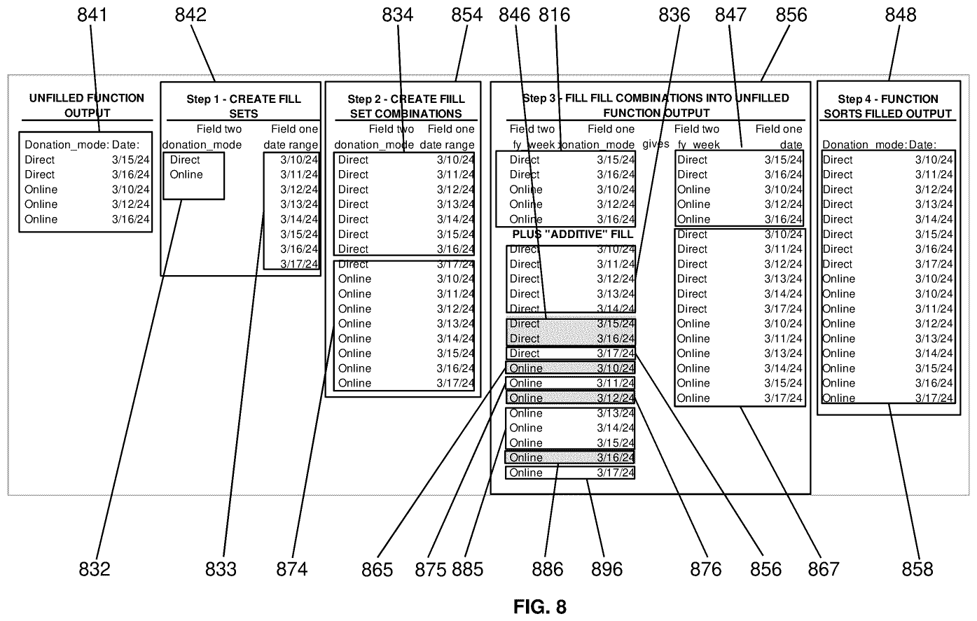

FIG. 7A through FIG. 8 examples the same embodiment as the example in FIG. 5A through FIG. 6 except in this example the user has overridden the default fill set for the field/range ‘date’ in the fill parameter ‘FILL[date{‘3/1//24’ . . . ‘3/17/2024’}, donation_mode]’ 728. That fill parameter in the formula 717 in cell ‘A1’ 736 adds the combination fill values to the function populated cells ‘A1’ through ‘B18’ 766 in FIG. 7B. The fill parameter ‘date’ field has the fill set in the curly brackets which overrides the default fill set with the date range fill set in this embodiment. The filled result has dates ‘3/10/2024’ incremented by one through ‘3/17/2024’ filled for each of the ‘Donation_mode:’ values ‘Direct’ 756 and ‘Indirect’ 776. While the unfilled output 743 in FIG. 7A has substantially less outputs from its formula 713 for the same cell ‘A1’ 732. FIG. 8 illustratively examples the steps employed by our technology which starts with the Unfilled Function Output′ 841. Step 1′ 842 then creates the fill lists for the fields/ranges involved in the filling of the unfilled values 841. In this example the ‘donation_mode’ values 832 are all the unique values (‘Direct’ and ‘Indirect’) for that field/range while the ‘date’ fill set is a user specified range of values from ‘‘3/10/2024’ . . . ‘3/17/2024’ ‘that our technology automatically increments the intervening values as shown in 833. ‘Step 2’ 854 then creates cross joined combinations of those fill sets as exampled for ‘donation_mode’ ‘Direct’ 834 and ‘donation_mode’ ‘Indirect’ 874 in this example. The cross join also works as illustratively exampled in FIG. 51A giving the illustrative result in FIG. 51B. As FIG. 51A examples (in ‘Example typed of fill sets’) there are many different ways in our technology to create the fill sets with FIG. 7B and FIG. 8 exampling the ‘All the unique data field/range values’ approach for ‘donation_mode’ fill set 832 and the ‘Incremented range from first to last data field/range value for integers and dates only’ approach for the ‘date’ field/range fill set 833. ‘Step 3’ 856 then adds any otherwise not present combination values (836, 856, 875, 885, and 896) from the cross joins (836, 846, 856, 865, 875, 876, 885, 886, and 896) eliminating any combination values already present (846, 865, 876, and 886) in the unfilled values (816) as shown in 847 (unfilled) and 867 (fill). Then the normal sorting of the results by the table generator function kicks in as exampled in ‘Step 4’ 848 to give the results 858 returned to cells ‘A1’ through ‘B18’ 776 in FIG. 7B.

### List Fill and Range Fill (Integer)

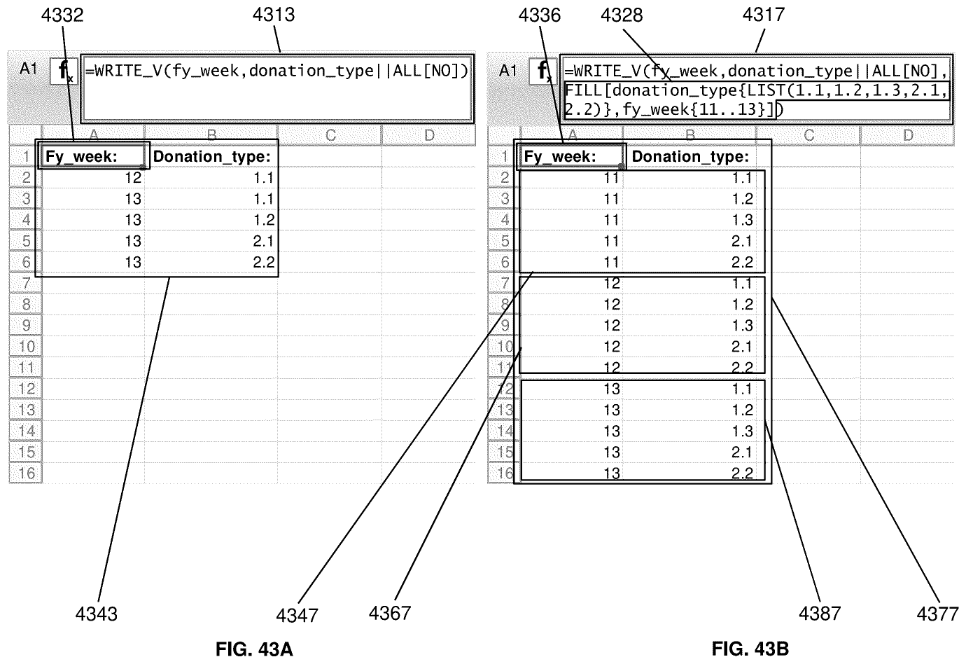

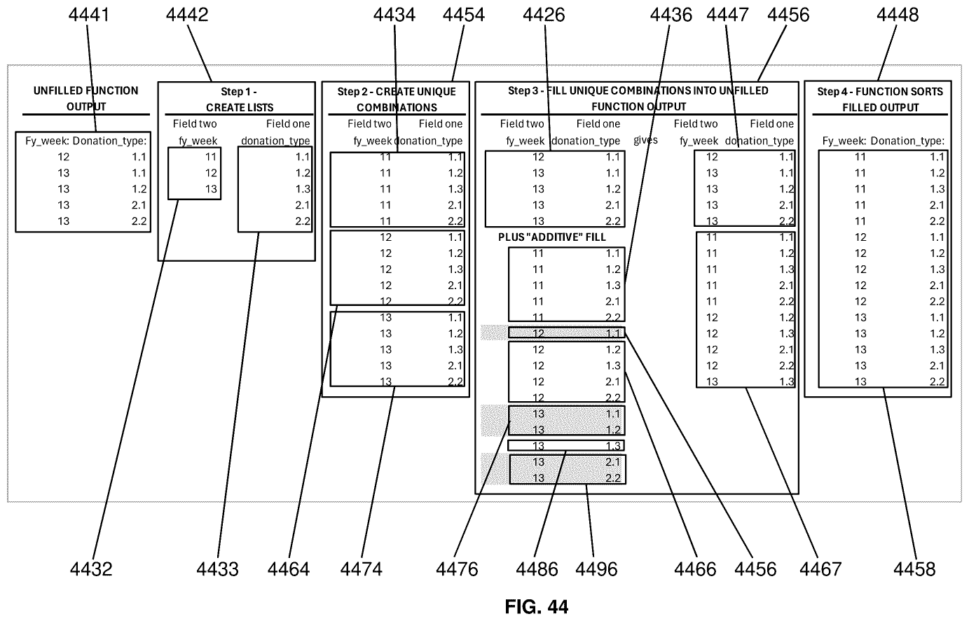

FIG. 43A through FIG. 44 examples the same embodiment as the examples in FIG. 5A through FIG. 8 except in this example the user has used a ‘Specified list of values’ fill for ‘donation_type’ and a ‘Incremented range from first to last specified values for integers and dates only’ fill for ‘fy_week’ as exampled in the ‘FILL[donation_type{LIST(1.1, 1.2, 1.3, 2.1, 2.2)}, fy_week{11 . . . 13}]’ 4328 fill parameter in the formula 4317 in cell ‘A1’ 4336. This populates the cells ‘A1’ through ‘B16’ 4377. The filled result repeats the ‘donation_type’ list of 1.1, 1.2, 1.3, 2.1, 2.2 for each value of the “Fy_week:’ range values of ‘11’ 4347, ‘12’ 4367, and ‘13’ 4387. While the unfilled output 4343 in FIG. 43A has substantially less outputs from its formula 4313 for the same cell ‘A1’ 4332. FIG. 44 illustratively examples the steps employed by our technology which starts with Step 1′ 4442 creating the fill sets for the fields/ranges involved in the filling of the unfilled values 4441. In this example the ‘donation_type’ fill set values 4432 are provided by the user specified list ‘LIST(1,1.2,1.3,2.1,2.2)’ while the ‘fy_week’ fill set is a user specified range of values from ‘11’ to ‘13’ that our technology automatically increments the intervening value as shown in 4432. ‘Step 2’ 4454 then creates cross joined combinations of those individual fill sets as exampled by the combination values for ‘fy_week’ values of ‘11’ 4434, ‘12’ 4464, and ‘13’ 4474. The cross join also works as illustratively exampled in FIG. 51A giving the illustrative result in FIG. 51B. As FIG. 51A examples there are many different ways in our technology to create the fill sets with FIG. 43B and FIG. 44 exampling the ‘Specified list of values’ approach for the ‘donation_type’ fill set 4433 and the ‘Incremented range from first to last data field/range value for integers and dates only’ approach for the ‘fy_week’ field/range fill set 4432. ‘Step 3’ 4456 then adds any otherwise not present value combinations (4436, 4466, and 4486) from the cross joins eliminating any value combinations already present (4456, 4476, and 4496) in the unfilled values (4426) as shown in 4447 (unfilled) and 4467 (fill). Then the normal sorting of the results by the table generator function kicks in as exampled in ‘Step 4’ 4448 to give the results 4458 returned to cells ‘A1’ through ‘B16’ 4377 in FIG. 43B.

### Filled and Unfilled Outputs

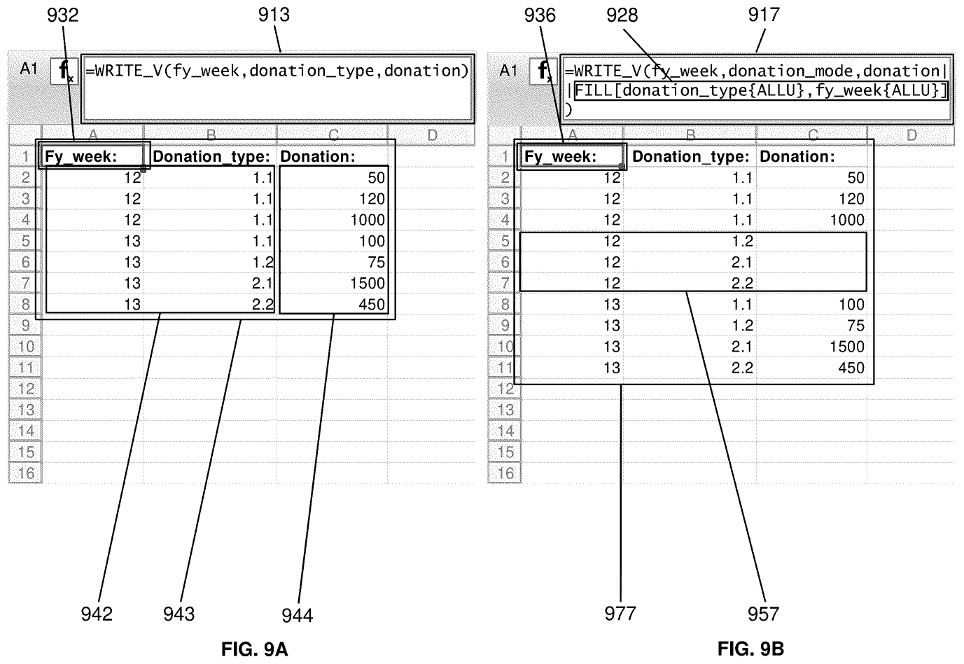

So far, our examples have been for situations where all the fields/ranges in the table generator output were involved in the combination fills. FIG. 9A through FIG. 11 examples a situation with an additional field/range output that is not included in the fill combinations. The user wants repeating combinations of all the unique values for ‘fy_week’ and ‘donation_types’ while also outputting their ‘donation’ values.

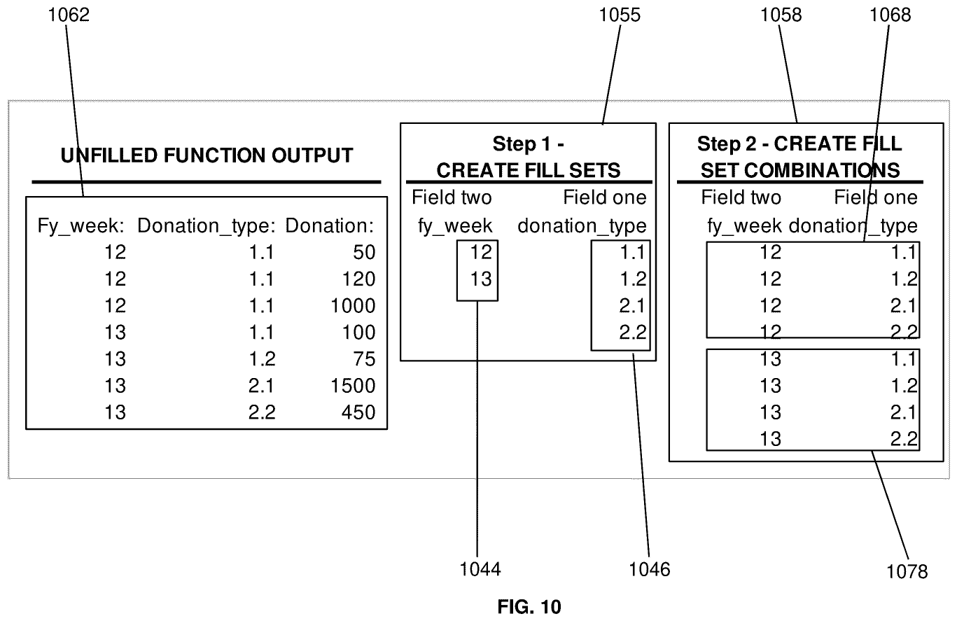

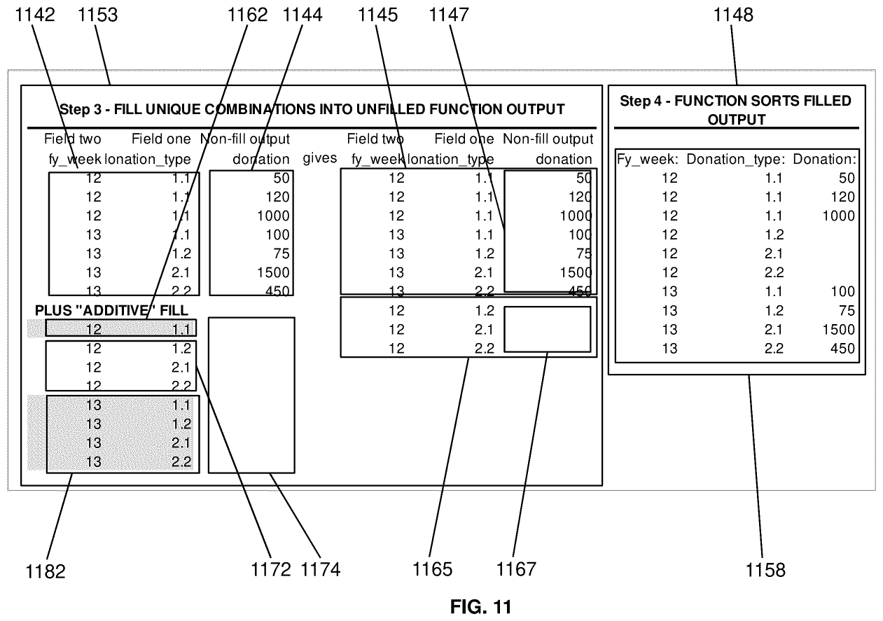

FIG. 9A examples the unfilled ‘WRITE_V’ functional formula for the cell ‘A1’ 932 which populates the cells ‘A1’ through ‘C8’ 943 from the formula 913. However, the user wants a complete set of ‘donation_type’ values populated from each ‘fy_week’ and therefore in this embodiment of our technology adds an optional argument ‘FILL[donation_type{!ALL},fy_week{!ALL}]’ 928 to the ‘WRITE_V’ functional formula 917 in cell ‘A1’ 936 which populates the cells ‘A1’ through ‘C11’ 977. This addition has resulted in the filling of the combination ‘Fy_week:’ and ‘Donation_type:’ values 957 which were not present in the unfilled values 942 in FIG. 9A (also adding corresponding blank/null/empty values 957 for the ‘Donation:’ values which were not present in the unfilled ‘Donation’ values 944 in the unfilled total output 943). Those combination fill values include blank or empty values for their ‘Donation:’ outputs as shown in 957 in FIG. 9B. That is because the ‘Donation:’ outputs are not included in the fill combination and therefore our technology leaves those values blank, null, or empty during the filling as exampled in the illustrative steps in FIG. 10 and FIG. 11. Note, the fill parameter syntax is a little different in this embodiment as all unique creation of the fill list is triggered by the ‘ALLU’ specifier within the curly brackets of each field/range fill specification. This is just one of many different variants for specifying the different fill set approaches supported by our technology.

FIG. 10 and FIG. 11 illustratively example the filling steps employed by our technology which starts with Step 1′ 1055 in FIG. 10 creating the fill lists for the fields/ranges involved in the filling of the unfilled values 1062. In this example the ‘donation_type’ fill set values 1046 are all the unique values for that field/range while the ‘fy_week’ fill set values 1044 are all the unique values for that field/range. ‘Step 2’ 1058 then creates cross joined combinations of those individual fill sets as exampled for ‘fy_week’ ‘12’ 1068 and ‘fy_week’ ‘13’ 1078 in this example. The cross join also works as illustratively exampled in FIG. 51A giving the illustrative result in FIG. 51B. ‘Step 3’ 1153 in FIG. 11 then adds any otherwise not present values from the cross joins (1172) eliminating any values already present (1162 and 1182) in the unfilled values (1142) as shown in 1145 (unfilled) and 1165 (fill). The difference in this situation versus the previous examples is that the non-fill outputs ‘donation’ values (1144 and 1147) are included, and the filled values have blanks, nulls or empty outputs for their corresponding ‘donation’ values as shown in 1174 and 1167. Then the normal sorting of the results by the table generator function kicks in as exampled in ‘Step 4’ 1148 to give the results 1158 returned to cells ‘A1’ through ‘C11’ 977 in FIG. 9B.

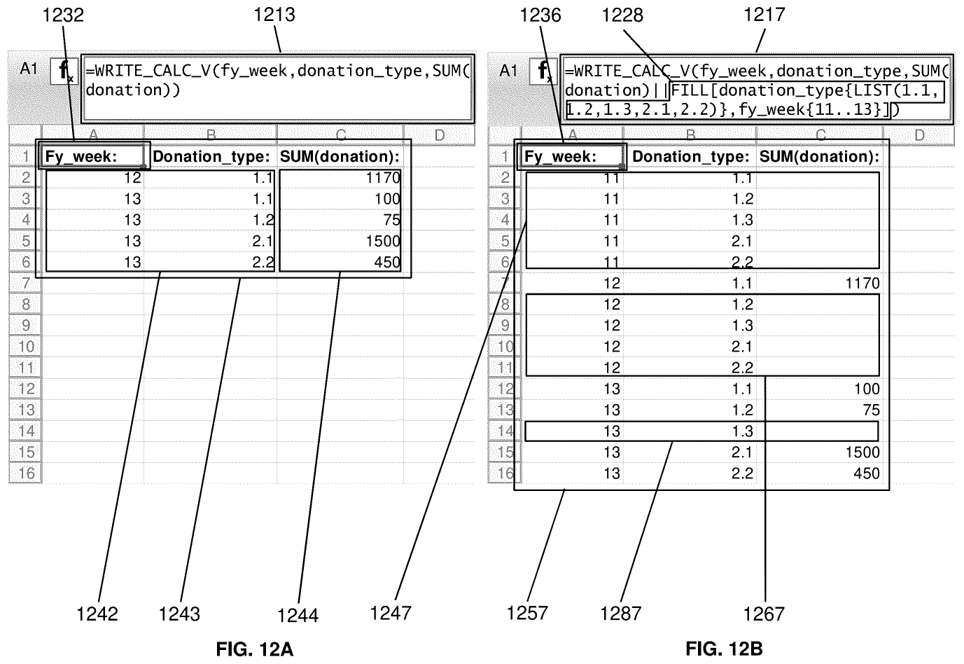

FIG. 12A through FIG. 14 examples how our technology works in the same manner for a table generator function with non-fill outputs generated by the simple functional formula ‘SUM(donation)’. Although our technology works for much more complicated algebraic formulas (e.g., ‘(donation-fees)/donation’) and combination algebraic and functional formulas (e.g., ‘(SUM(donation)−SUM (fees)/COUNT (donations)’).

FIG. 12A examples the unfilled ‘WRITE_CALC_V’ functional formula 1213 for the cell ‘A1’ 1232 which populates the cells ‘A1’ through ‘C6’ 1243. However, the user wants a list of ‘donation_type’ values populated for a range of ‘fy_week’ values (cross joined) and therefore in this embodiment of our technology adds an optional argument:

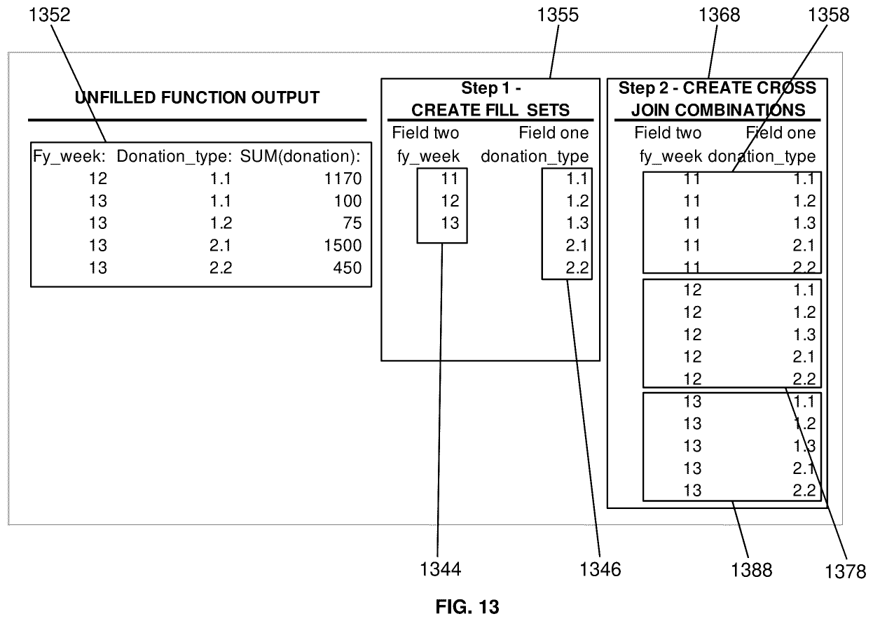

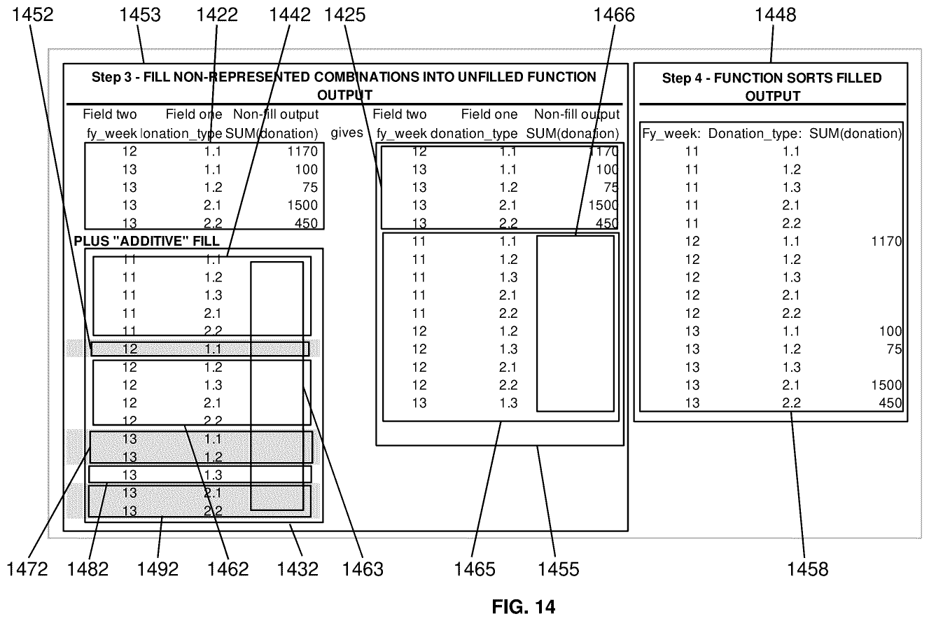

‘FILL[donation_type{LIST(1.1,1.2,1.3,2.1,2.2)},fy_week{11 . . . 13}]’ 1228 to the ‘WRITE_CALC_V’ functional formula 1217 in cell ‘A1’ 1236 which populates the cells ‘A1’ through ‘C16’ 1257. This fill parameter 1228 (argument) addition has resulted in the filling ‘Fy_week’ and ‘Donation_type’ combination values 1247, 1267, and 1287 which were not present in the unfilled values 1242 in FIG. 12A (also adding corresponding blank/null/empty ‘SUM(donation):’ values in 1247, 1267, and 1287 to the unfilled values 1244 that are in the unfilled total output 1243). Those fill values include blank or empty values for their ‘SUM(donation):’ outputs as shown in the filled output 1257 in FIG. 12B. That is because the ‘SUM(donation):’ outputs are not included in the fill combination and therefore our technology leaves those values blank, null, or empty as exampled in the illustrative steps in FIG. 13 and FIG. 14.

FIG. 13 and FIG. 14 illustratively example the steps employed by our technology which starts with Step 1′ 1355 in FIG. 13 creating the fill lists for the fields/ranges involved in the filling of the unfilled values 1352. In this example the ‘donation_type’ fill set values 1346 are the list ‘1.1, 1.2, 1.3, 2.1, 2.2’ specified by the user for that field/range fill while the ‘fy_week’ fill set values 1344 are the range ‘11 . . . 13’ specified by the user for that field/range fill. ‘Step 2’ 1368 then creates cross joined combinations of those individual fields/range fill sets as exampled for ‘fy_week’ ‘11’ 1358, ‘fy_week’ ‘12’ 1378, and ‘fy_week’ ‘13’ 1388 in this example. The cross join also works as illustratively exampled in FIG. 51A giving the equivalent of the illustrative result in FIG. 51B. ‘Step 3’ 1453 in FIG. 14 then adds any otherwise not present values from the cross joins (1442, 1462, and 1482) eliminating any fill values (grayed out rows in 1432) already present (1452, 1472, and 1492) in the unfilled values (1422) as shown in 1425 (unfilled) and 1465 (fill). It also delivers the fill outputs ‘SUM(donation)’ values (1463 and 1466) with blanks, nulls, or empty outputs. Then the normal sorting of the results by the table generator function kicks in as exampled in ‘Step 4’ 1448 to give the results 1458 returned to cells ‘A1’ through ‘C16’ 1257 in FIG. 12B.

### Different Fill Parameter Syntax

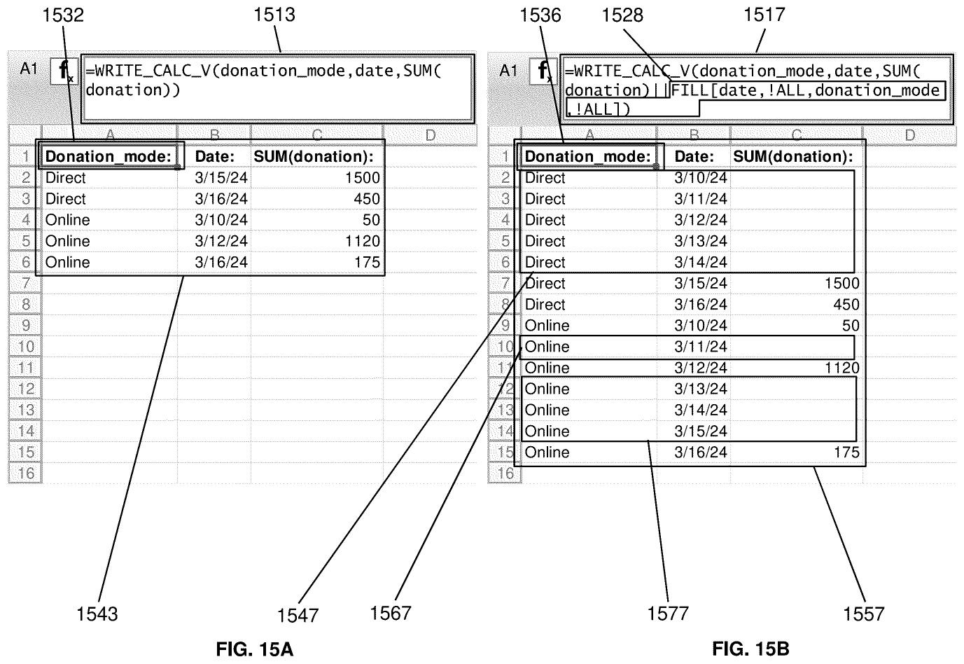

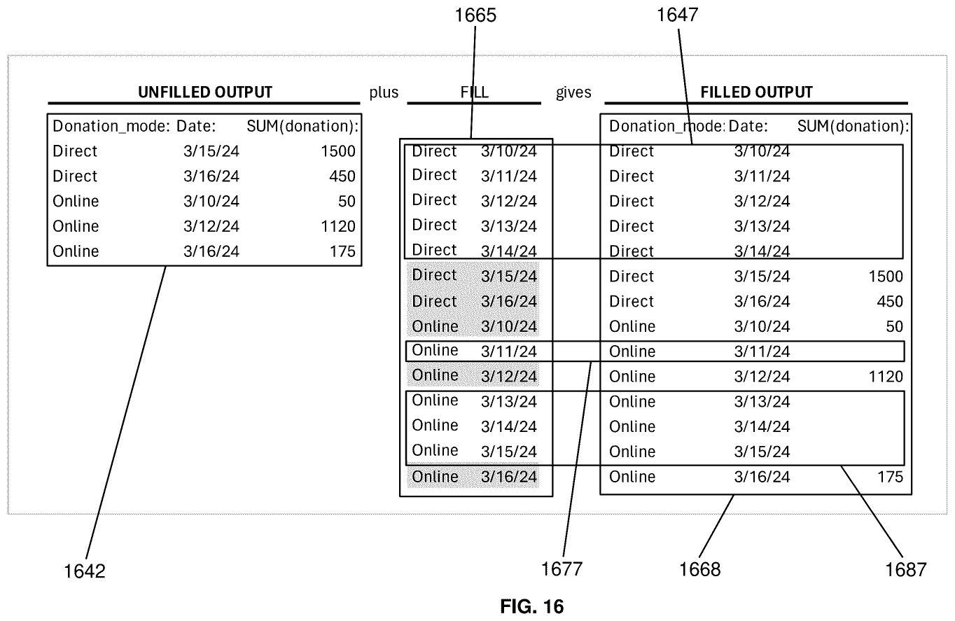

As previously mentioned, our combination fill technology supports many different syntaxes used by the fill parameter or argument(s). FIG. 15A through FIG. 16 examples one such variant where the syntax is a repetitive pair of the combination field/range in one ‘FILL’ parameter argument and the fill set specification in the next ‘FILL’ parameter argument as exampled in the fill parameter in FIG. 15B:
‘FILL[date,!ALL,donation_mode,!ALL]’ 1528

Where ‘date,!ALL’ is the first repetitive pair and ‘donation_mode,!ALL’ is the second repetitive pair. Although our technology would support more pairs up to including all of the fields in the functional formula. This results in formula 1517 in cell ‘A1’ 1536 populating the cells ‘A1’ through ‘C15’ 1557 while the unfilled output 1543 in FIG. 15A has substantially less outputs 1543 from its formula 1513 for the same cell ‘A1’ 1532. FIG. 16, for brevity's sake, illustratively examples an abbreviated set of steps collapsing down a number of the more detailed steps we have already exampled. It starts with the unfilled output 1642 and then collapses the creation of the fill sets and the cross join of those fill sets to ‘FILL’ combination values 1665 used in the filling of the unfilled values 1642. Those non-represented (in the unfilled values 1642) fill combination values 1647, 1677, and 1687 are then filled to give the ‘FILLED OUTPUT’ 1668 which is returned with the functional sorting to give the results returned to cells ‘A1’ through ‘C15’ 1557 in FIG. 15B.

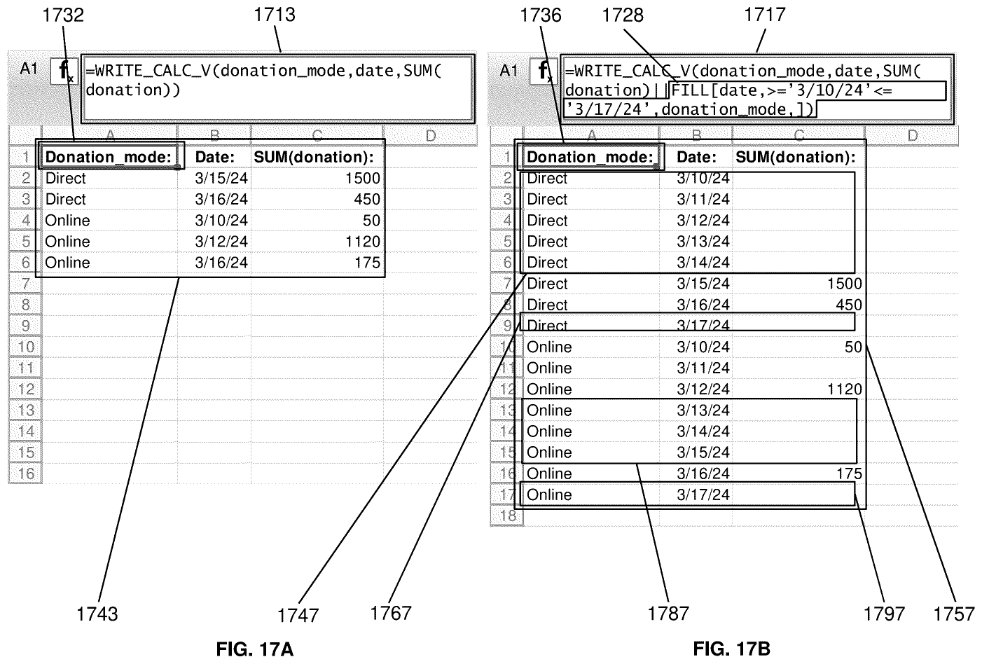

FIG. 17A and FIG. 17B examples another fill parameter situation employing the repetitive pair of the combination field/range in one ‘FILL’ parameter argument and the fill set specification in the next ‘FILL’ parameter argument as exampled in the fill parameter in FIG. 17B:
‘FILL[date,>=‘3/10/2024’<=‘3/17/2024’,donation_mode, ,]’ 1728
   Where ‘date,>=‘3/10/2024’<=‘3/17/2024” is the first repetitive pair with a fill set range and ‘donation_mode, ,’ is the second repetitive pair where the empty argument (‘, ,’} defaults to all the values of ‘donation_mode’ as its fill set. This is exampled in the output of the functional formula 1717 for cell ‘A1’ 1736 in FIG. 17B which cross join fills both the ‘Donation_mode:’ ‘Direct’ values with the range of dates ‘3/10/2024, 3/11/2024, 3/12/2024, 3/13/2024, 3/14/2024, 3/15/2024, 3/16/2024, 3/17/2024’ filling the combination values 1747 and 1767 (with the ‘SUM(donation)’ values blank) and the ‘Donation_mode:’ ‘Indirect’ values with the same range of dates ‘3/10/2024, 3/11/2024, 3/12/2024, 3/13/2024, 3/14/2024, 3/15/2024, 3/16/2024, 3/17/2024’ filling the combination values 1787 and 1797 (with the ‘SUM(donation)’ values blank). Thus, the formula in the filled ‘WRITE_CALC_V’ function outputs to many more cells ‘A1’ through ‘C17’ 1757 than the same formula 1713 for cell ‘A1’ 1732 in FIG. 17A which populates cells ‘A1’ through ‘C6’ 1743 without the fill parameter 1728 in FIG. 17B.

Note, in the examples thus far the order of the arguments within the fill function or argument has had the field/column farthest to the right in the output first and then arguments followed by filling fields to the left in the output. However, our technology supports different orders where the fill fields/columns are instead listed in their order of output in the functional formula. So, in the example in FIG. 15B the ‘donation’,!ALL′ would come before the ‘date,!ALL’. Also note that in the examples thus far the fill parameter has been keyword named (e.g., ‘FILL’), however it could be incorporated into the syntax of the prebuilt function it is used in (i.e., the spreadsheet prebuilt table populating function) without a keyword naming of the argument or arguments. Our technology also supports the fill parameter being a prebuilt function containing arguments as will be exampled later.

### Three Different Integer Fill Sets

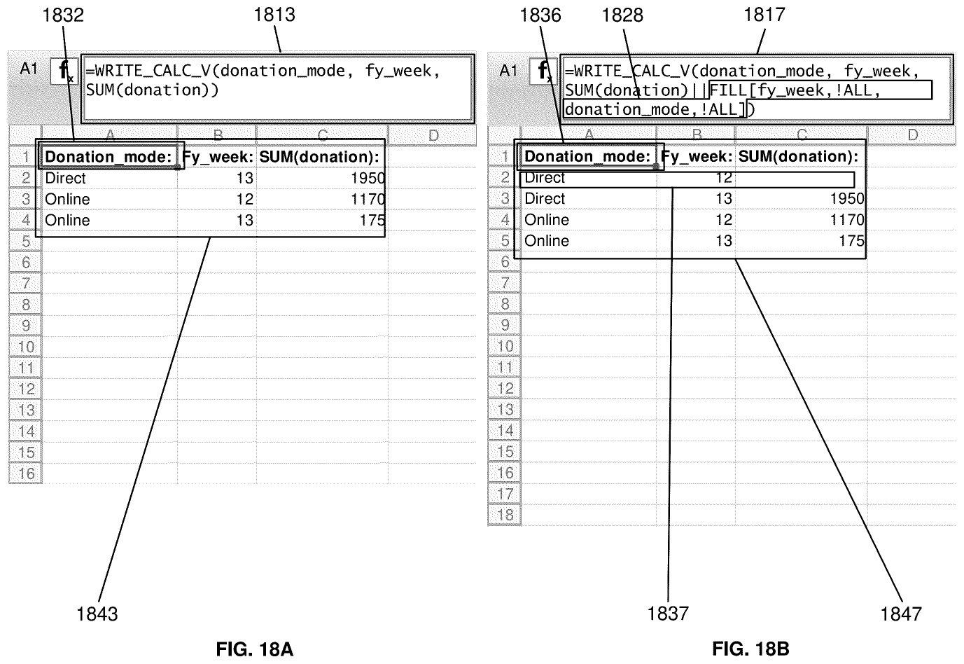

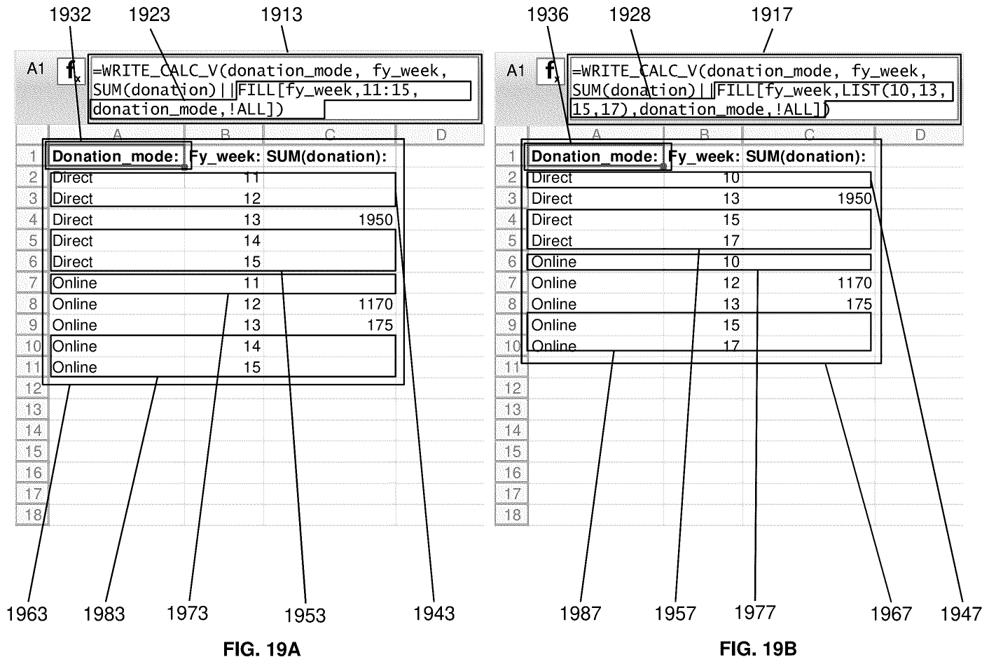

FIG. 18B, FIG. 19A and FIG. 19B examples three of the many different integer combination fill set cross join fills for the ‘WRITE_CALC_V’ unfilled functional formula in FIG. 18A. That functional formula 1813 for cell ‘A1’ 1832 in FIG. 18A populates the cells ‘A1’ through ‘C4’ 1843 where the addition of the combination cross join fill sets fill parameter 1817 (specifying ‘!ALL’ both the ‘fy_week’ integer fill set and the ‘donation_mode’ text fill set) in the functional formula 1817 for cell ‘A1’ 1836 in FIG. 18B populates the cells ‘A1’ through ‘C5’ 1847 having filled the ‘Direct’ and ‘12’ combination 1837. Whereas, if the fill parameter was instead 1923 in FIG. 19A (specifying the range ‘11 . . . 13’ for the integer field/range ‘fy_week’ and ‘!ALL’ for the ‘donation_mode’ text fill set) in the functional formula 1913 for cell ‘A1’ 1932, the result it populates is the cells ‘A1’ through ‘C11’ 1963 having filled the ‘Direct’ ‘Donation mode:’ values with 1943 and 1953 and the ‘Indirect’ ‘Donation_mode:’ values with 1973 and 1983. And if the fill parameter was instead 1928 in FIG. 19B (specifying the ‘LIST(10,13,15,17)’ for the integer field/range ‘fy_week’ and ‘!ALL’ for the ‘donation_mode’ text fill set) in the functional formula 1917 for cell ‘A1’ 1936, the result it populates is the cells ‘A1’ through ‘C10’ 1967. Thus, having filled the ‘Direct’ ‘Donation mode:’ values with 1947 and 1957 and the ‘Indirect’ ‘Donation mode:’ values with 1977 and 1987. All these fill parameters create fill sets, then cross join those fill sets, fill the non-represented combinations into the unfilled function output (in these examples 1843 in FIG. 18A) and then support the normal sorting of the values by the function as previously exampled.

### Two Different Text Fill Sets Employing a Different Fill Parameter Location

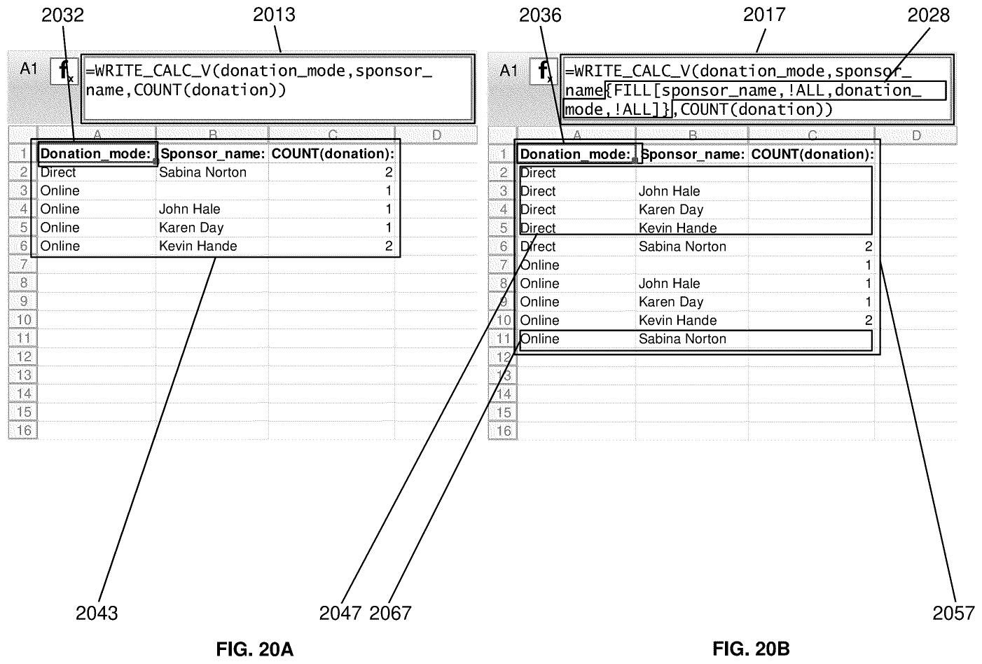

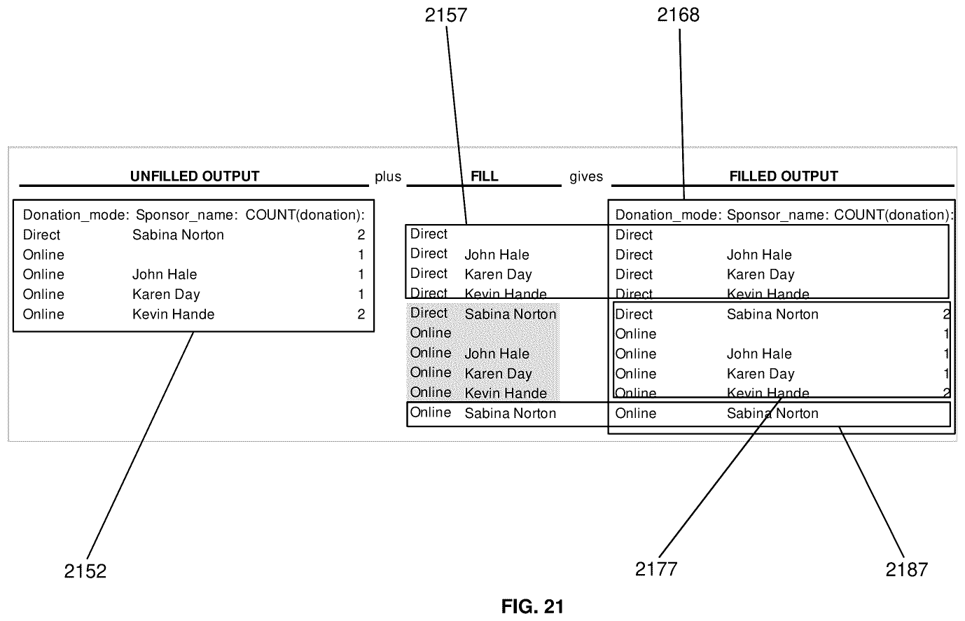

As previously exampled our technology supports different fill parameter syntaxes and for those different syntaxes it supports the use of the fill parameter in different locations within the functional formulas. The previous examples had the fill parameter as an optional argument added to the spreadsheet prebuilt function, FIG. 20A through FIG. 21 examples the fill parameter instead used within an existing argument of the function through its addition to a field/range argument.

FIG. 20A examples the unfilled ‘WRITE_CALC_V’ functional formula 2013 for the cell ‘A1’ 2032 which populates the cells ‘A1’ through ‘C6’ 2043. FIG. 20B examples the combination filled ‘WRITE_CALC_V’ functional formula 2017 for the cell ‘A1’ 2036 which populates the cells ‘A1’ through ‘C11’ 2057. The fill parameter 2028 is added to the field/range ‘sponsor_name’ within the ‘sponsor_name’ argument curly brackets:
sponsor_name{FILL[sponsor_name,!ALL,donation_mode,!ALL]}
   The fill parameter is within the ‘sponsor_name’ argument of the ‘WRITE_CALC_V’ function as a modifier of the field/range ‘sponsor-name’ in this embodiment placed within the curly brackets. Thereby exampling the flexibility of incorporating our combination filling technology within the argument structure of existing and future spreadsheet prebuilt functions. FIG. 20B examples the result of the combination fill parameter 2028 adding the combination fill rows 2047 and 2067 to the output 2057. FIG. 21 illustratively examples, in abbreviated form, our technology automatically starting with the unfilled output 2152 and then adding the fill sets cross join combinations 2157 and 2187 that are not represented in the unfilled field combinations 2177 to then deliver the filled output 2168 sorted by the function to the cells ‘A1’ through ‘C11’ 2057 in FIG. 20B. Note, in this example of our combination fill technology the fill argument is added to the last field/column in the formula which is part of the fill combination. However, our technology supports it being added instead to the first field/column in the formula which is part of the fill combination, which is not exampled here for brevity's sake.

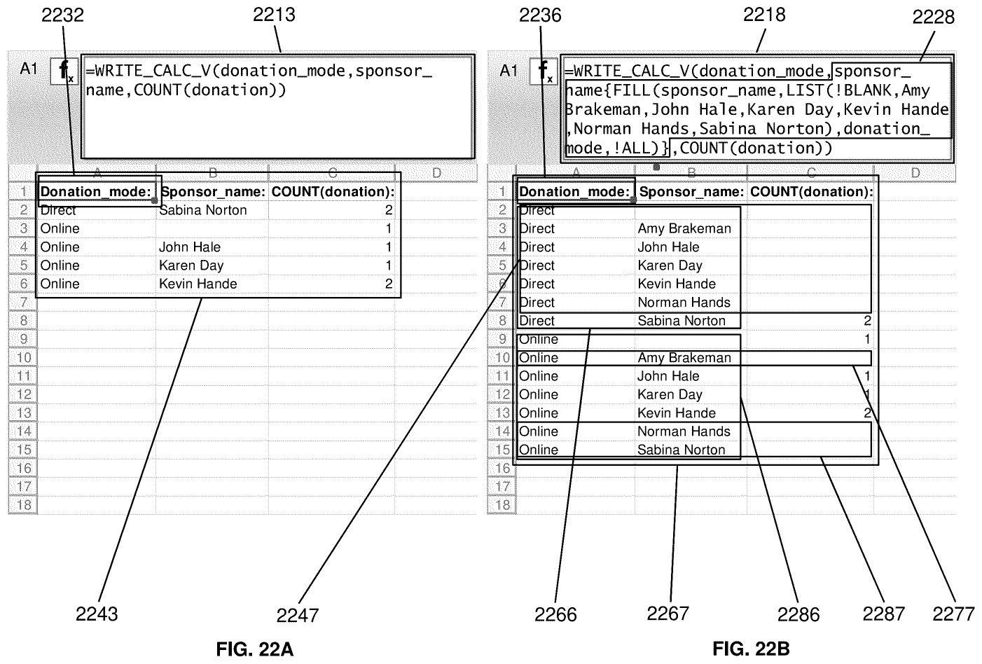

FIG. 22A and FIG. 22B also examples the fill parameter (a FILL prebuilt function) used (as a modifier) within an existing argument of the function through its addition to that field/range argument with a text list fill setting and a text ‘!ALL’ fill setting. FIG. 22A examples the unfilled ‘WRITE_CALC_V’ functional formula 2213 for the cell ‘A1’ 2232 which populates the cells ‘A1’ through ‘C6’ 2243. FIG. 22B examples the combination filled ‘WRITE_CALC_V’ functional formula 2218 for the cell ‘A1’ 2236 which populates the cells ‘A1’ through ‘C15’ 2267. The fill parameter 2228, that includes a ‘FILL’ prebuilt function employing a LIST(prebuilt function) of text fill set values, is added to the field/range ‘sponsor_name’ within the ‘sponsor_name’ argument curly brackets:
‘sponsor_name{FILL(sponsor_name,LIST(!BLANK,Amy Brakeman,John Hale, Karen Day,Kevin Hande,Norman Hands,Sabina Norton),donation_mode,!ALL)}’ 2228
   So that it all resides within the ‘sponsor_name’ argument of the ‘WRITE_CALC_V’ function and delivers the filling of the function output adding the rows 2247, 2277, and 2287 to the output 2267. It delivers the complete list of ‘sponsor_name’ values specified in the fill parameter for each of the ‘Donation_mode’ ‘Direct’ 2266 and ‘Online’ 2286 values using the automatic mechanisms already exampled.

### Cell Reference Used in Fill Parameter

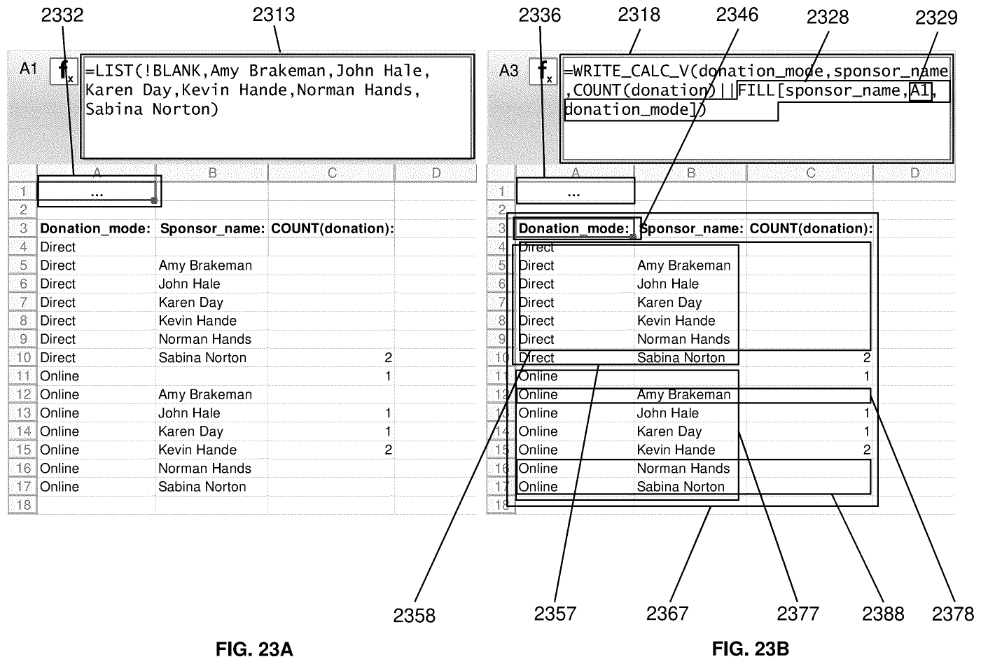

Our technology also supports specification of a fill set by cell reference as exampled in FIG. 23A and FIG. 23B. This works for multiple values because our technology supports the storage and then formulaic usage of multiple values within a single cell as per U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023. In this example it uses our ‘LIST’ function for delivering the multiple values, but it would also work for our other functions and capabilities that store for cell reference usage multiple values. For example, our spreadsheet prebuilt function in U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023 and our spreadsheet prebuilt functions (e.g., INPUT_RANGE and INPUT_MULTIPLE) and our spreadsheet capabilities (e.g., multi-value validation values and range) in U.S. Provisional Application No. 63/622,515, titled “Methods and Systems for a Family of Dual Entry Spreadsheet Functions, Improved Spreadsheet Validations, and Partial Locking of Spreadsheet Functions and Cell Capabilities,” filed 18 Jan. 2024.

FIG. 23A and FIG. 23B example the same spreadsheet cells simply highlighting two different cells to see their formulas. FIG. 23A examples the LIST function formula 2313 for the cell ‘A1’ 2332 which because it populates many different values in this embodiment displays a ‘ . . . ’ 2332 indicating it contains many values. Those values, shown in the formula 2313, are available for use by formulas referencing the cell ‘A1’. FIG. 23B examples the combination filled ‘WRITE_CALC_V’ functional formula 2318 for the cell ‘A3’ 2346 which populates the cells ‘A3’ through ‘C17’ 2367 referencing the cell ‘A1’ 2329 (A1 2336) in its fill parameter 2328. The fill parameter 2228 includes the cell ‘A1’ 2329 as the fill set for the first field (‘sponsor_name’) which then delivers the list of values shown in the ‘LIST’ formula 2313 in FIG. 23A for each of the ‘Donation_mode:’ ‘Direct’ 2357 and ‘Online’ 2377 values using the automatic mechanisms already exampled numerous times starting with the unfilled values, creating the fill sets, cross joining those fill sets, adding the unrepresented fill set combinations and then employing the sorting of the function. In the process filling the function output adding the rows 2358, 2378, and 2388 to the output 2367.

Note, while the fill parameter 2328 in FIG. 23B uses a single cell reference ‘A1’ 2329 referencing a cell containing one of our ‘LIST’ functions, that cell could have held one of our other functions which populate multiple values into one cell as in our U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023, and in our U.S. Provisional Application No. 63/622,515, titled “Methods and Systems for a Family of Dual Entry Spreadsheet Functions, Improved Spreadsheet Validations, and Partial Locking of Spreadsheet Functions and Cell Capabilities,” filed 18 Jan. 2024. The single cell reference could have also been replaced by a range of cells that collectively contain more than one value that would be used as the fill set.

### Reals

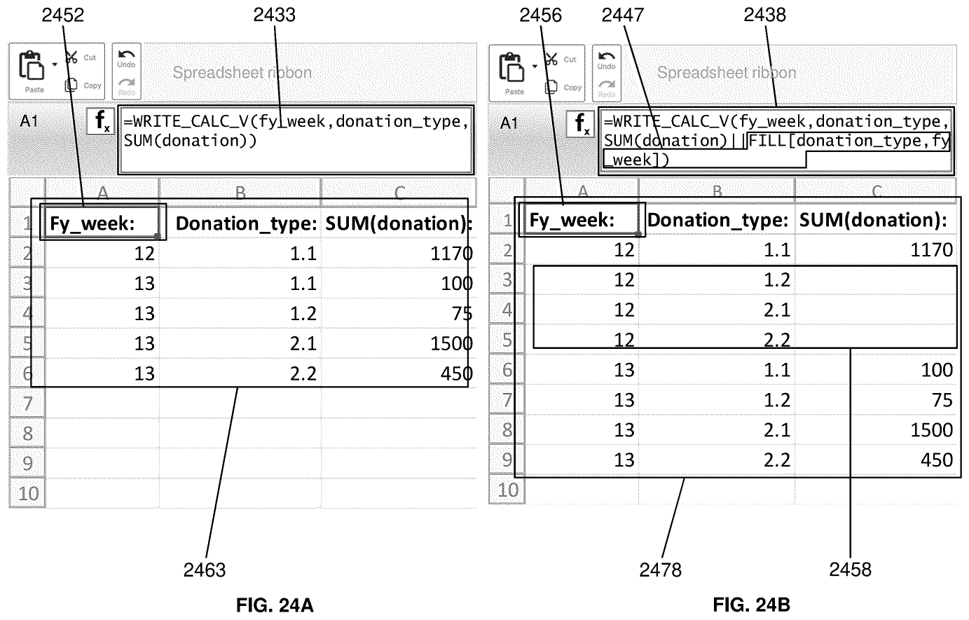

As we have discussed we support filling of all data types for a spectrum of fill sets. Filling of dates and integers in our technology supports range fill sets where our technology automatically increments the range one day for dates and one integer for integers for the entire range. A specialized range version is supported for reals where the user specifies the increments, so that if the user specified a range of ‘1.1 . . . 2.2’ with an increment of ‘0.1’ they would get a fill set of 1.1, 1.2, 1.3, 1.4, 1.5, 1.6, 1.7, 1.8, 1.9, 2.0, 2.1, and 2.2. FIG. 24A and FIG. 24B examples a much more typical situation of filling the reals with all the values that field/range holds. FIG. 24A examples the unfilled ‘WRITE_CALC_V’ functional formula 2433 for the cell ‘A1’ 2452 which populates the cells ‘A1’ through ‘C6’ 2463. FIG. 24B examples the combination filled ‘WRITE_CALC_V’ functional formula 2438 for the cell ‘A1’ 2456 which populates the cells ‘A1’ through ‘C9’ 2478. The fill parameter 2438 employed is in the option argument group of the function and employs the syntax where the fill type is part of the field/range argument within the fill parameter and in this example is the default setting of all unique field/range values (‘donation_type’ and ‘fy_week’ having no curly brackets containing a specification of a non-default fill set) by themselves. That results in the filling of the rows 2458 which are done as previously exampled with setting the fill sets, cross joining the fill set combinations, filling in the unrepresented combinations in the unfilled results, and then employing the function's sorting to give the complete filled results 2478.

### Booleans

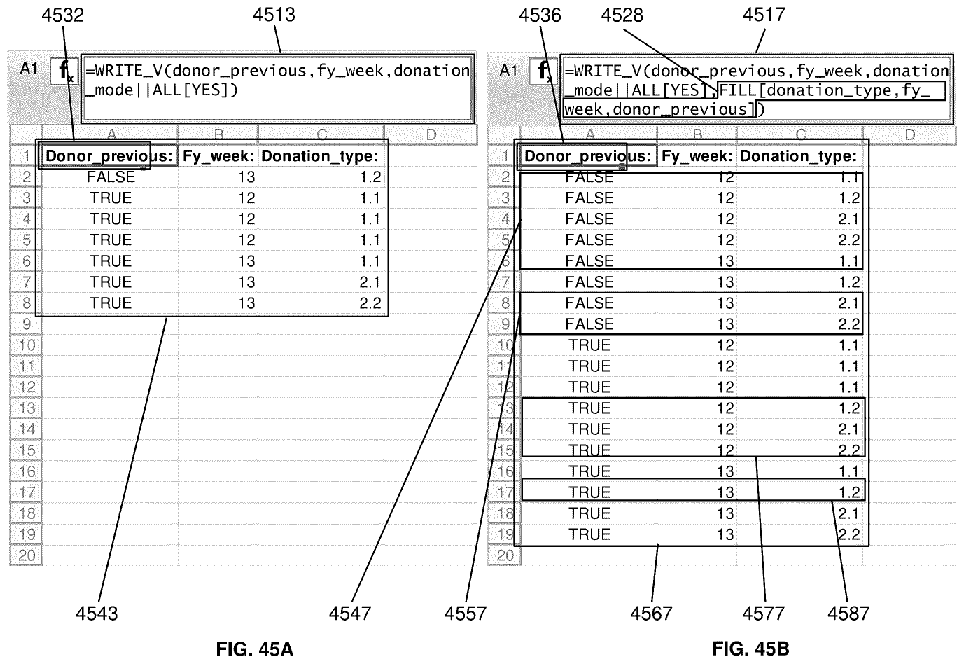

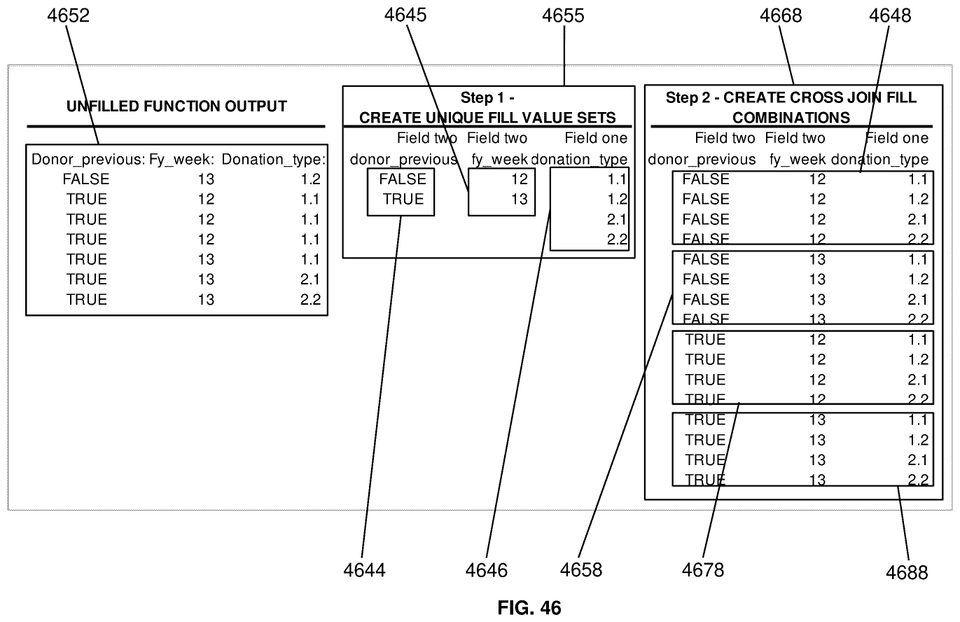

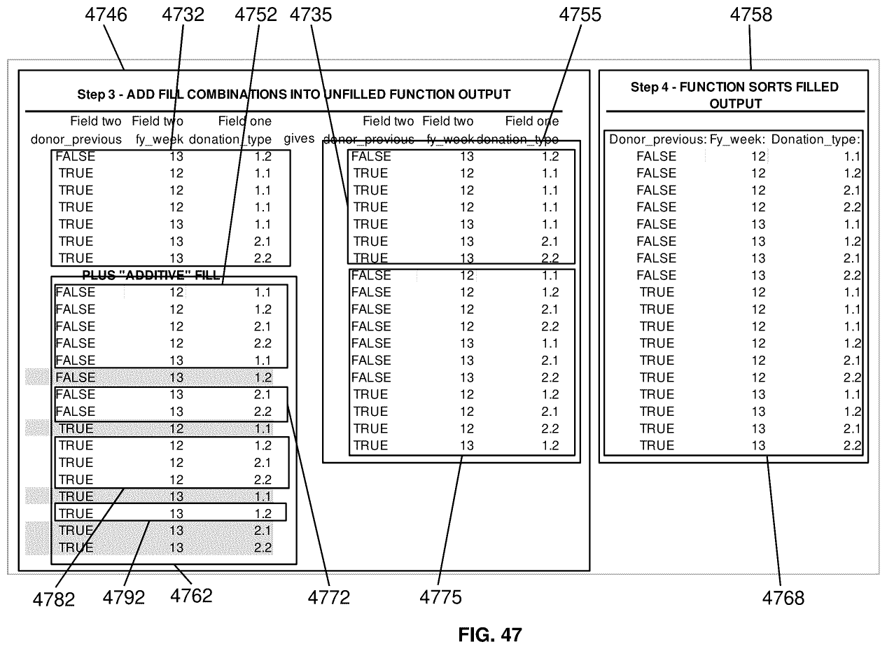

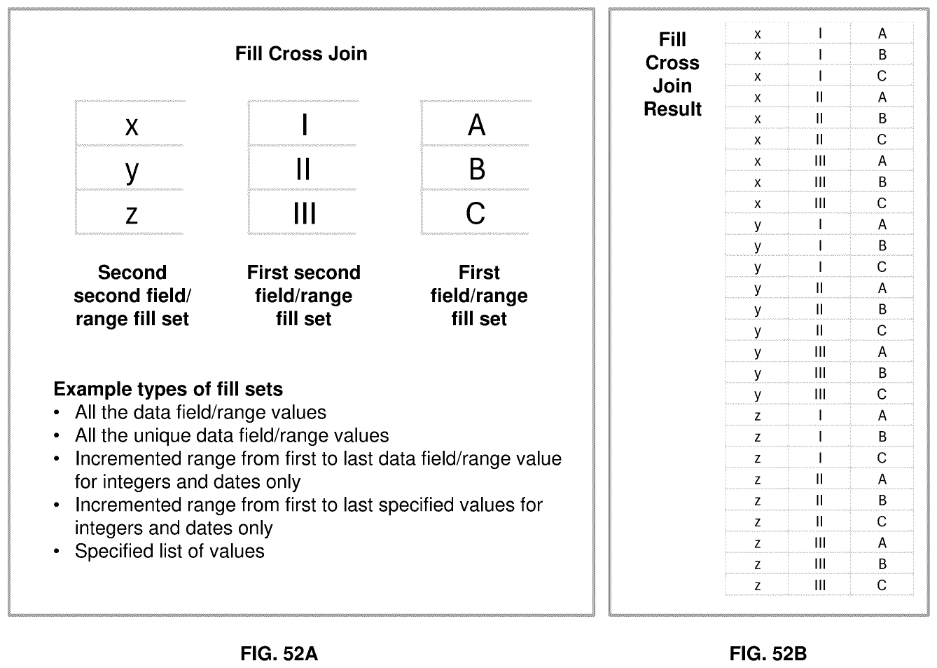

Our combination fill technology also supports filling Booleans, recognizing they have a much more limited set of options. FIG. 45A through FIG. 47 examples a triple combination fill of a ‘WRITE_V’ function employing fill field/ranges of data types Boolean, integer and real. FIG. 45A examples the unfilled ‘WRITE_V’ functional formula 4513 for the cell ‘A1’ 4532 which populates the cells ‘A1’ through ‘D8’ 4543. FIG. 45B examples the triple combination filled ‘WRITE_V’ functional formula 4517 for the cell ‘A1’ 4536 which populates the cells ‘A1’ through ‘C19’ 4567 with the fill rows 4547, 4557, 4577, and 4587. All three of fill parameter field/range fill set specifiers employ an implicit/default all unique values of the field/range. Although they could have employed any one of the different fill set types mentioned in FIG. 52A. FIG. 46 illustratively begins exampling the steps employed by our technology which starts with Step 1′ 4655 creating the three fill sets (4644, 4645, and 4646) for the fields/ranges involved in the filling of the unfilled values 4652. In this example all three of those fill sets are the unique set of values for the respective field/range. ‘Step 2’ 4668 then creates the cross joined fill combinations of those individual fill sets as exampled by the combination values for the ‘donor_previous’ and ‘fy_week’ combinations 4648, 4658, 4678, and 4688. The cross join works as illustratively exampled in FIG. 52A giving the illustrative result in FIG. 52B. ‘Step 3’ 4746 in FIG. 47 then adds any otherwise not present fill combinations from the cross joins (4752, 4772, 4782, and 4792) eliminating any value combinations already present (the grayed values in 4762) in the unfilled values (4732) as shown in 4755 (unfilled) and 4775 (fill). Then the normal sorting of the results by the table generator function kicks in as exampled in ‘Step 4’ 4758 to give the results 4768 returned to cells ‘A1’ through ‘C19’ 4567 in FIG. 45B.

### Function Constraint Constrains Combination Fill

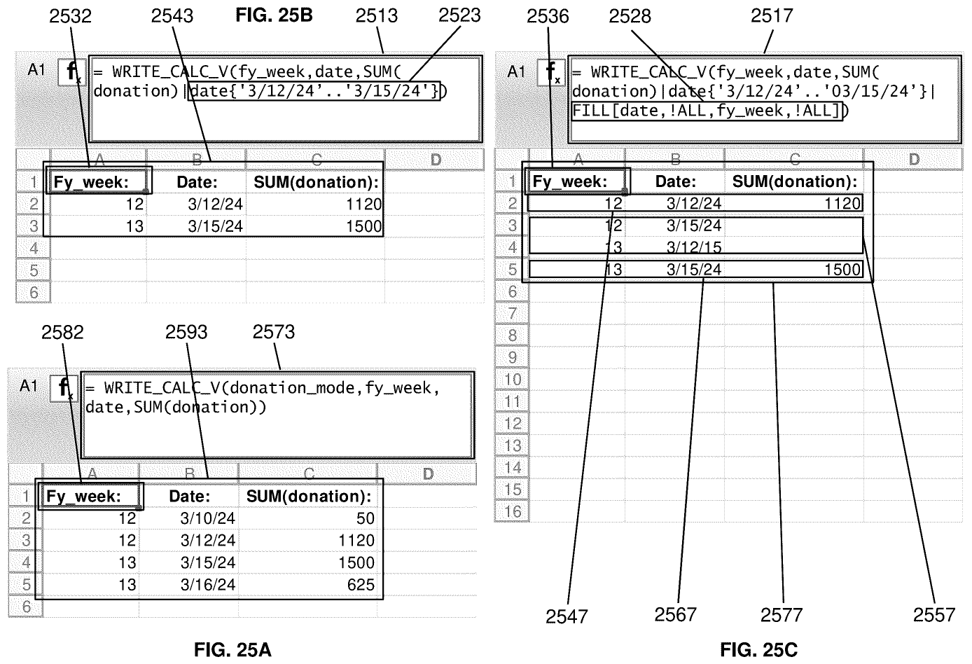

FIG. 25A through FIG. 25C examples the function formula constraint/filter constraining/filtering the combination fill values. FIG. 25A examples the function (in this situation a ‘WRITE_CALC_V’ prebuild function) result 2593 from the formula 2573 in cell ‘A1’ 2582 without a constraint/filter. FIG. 25B then examples the same function (in this situation a ‘WRITE_CALC_V’ prebuild function) result 2543 from the formula 2513 in cell ‘A1’ 2532 with a constraint/filter date range 2523. The result then has only two rows of values versus the four rows of values from the same formula without the constraint/filter. FIG. 25C then examples the same function (in this situation a ‘WRITE_CALC_V’ prebuild function) result 2577 from the formula 2517 in cell ‘A1’ 2536 with the same constraint/filter date range as FIG. 25B but with an added fill parameter 2528. In this embodiment the ‘!ALL’ fill set specifier employs all the unique values remaining after the functional formula constraint/filter rather than all the values for the respective fields before the functional formula constraint/filter application. So, in this example it therefore uses for the ‘date’ fill set the two dates (‘3/12/2024’ and ‘3/15/2024’) shown in the results 2543 after the application of the constraint in FIG. 25B rather than the four dates shown in the results 2593 before the application of the constraint in FIG. 25A. Those two dates are then used in cross fill combination with the two ‘fy_week’ values (‘12’ and ‘13’ which are not changed by the constraint/filter) post the application of the functional formula constraint/filter to add the fill values 2557 to the unfilled values 2547 and 2567 to give the filled output 2577. Note, depending upon the embodiment of our technology some of the fill set options are constrained/filtered by the functional formula constraint/filter and others are not. Our technology supports many different variants dealing with functional formula constraints/filters.

### Two Combination Fills Versus a Single Triple Combination Fill

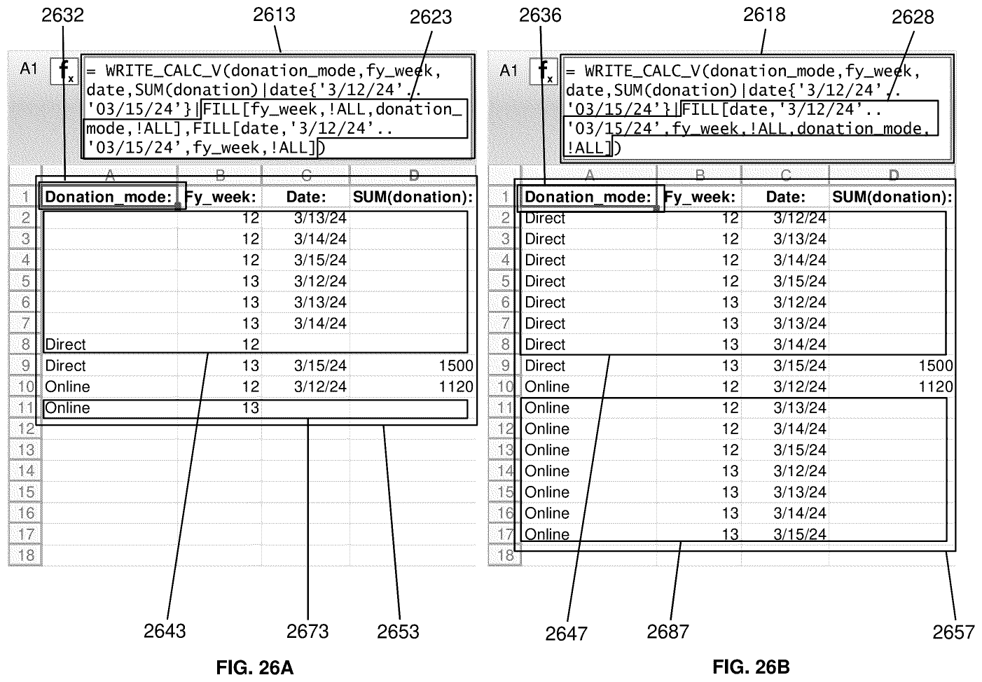

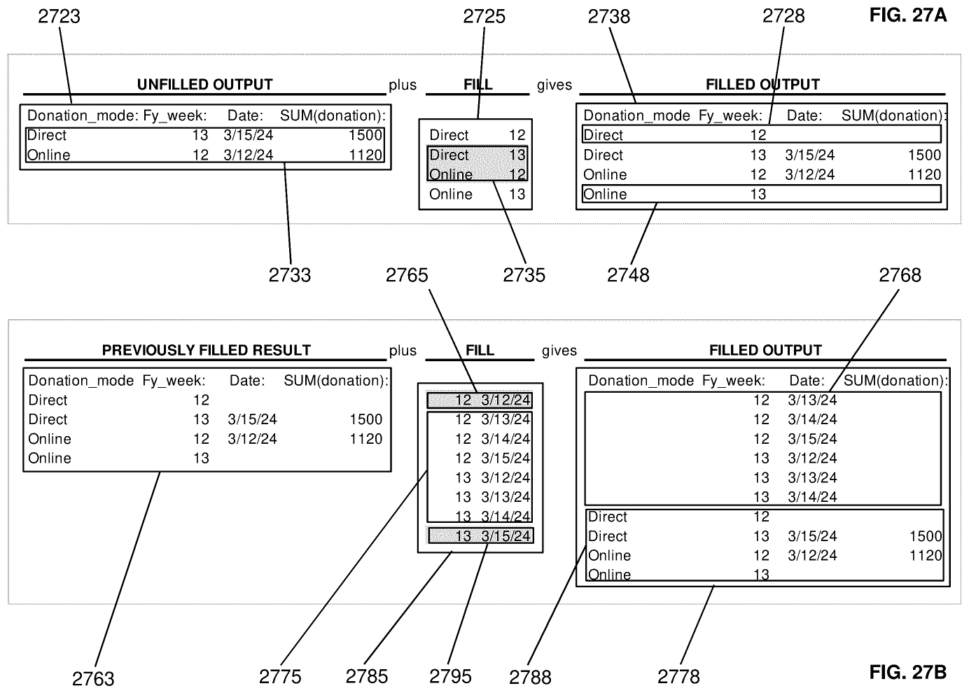

Our technology supports multiple combination fills within the same function as well as triple, quadruple and so on combination joins. FIG. 26A through FIG. 28 examples the differences in outcomes from two double combination fills versus one triple combination fill employing the same fill fields/ranges. FIG. 26A and FIG. 26B example the same ‘WRITE_CALC_V’ functional formula including a date constraint/filter ‘‘3/12/2024’ . . . 03/15/2024’’ with the difference in the fill parameters. FIG. 26A examples the application of two combination fills (employing two fill parameters 2623) within that functional formula 2613 in cell ‘A1’ 2632. This results in two rounds of filling as illustratively (abbreviated) exampled in FIG. 27A and FIG. 27B. FIG. 27A examples the first fill starting with the unfilled function output 2723 which has two rows of values 2733. Our technology then applies the first fill parameter cross join combination fill set 2725 (created as exampled cross joining the ‘donation_mode’ fill set of ‘Direct’ and ‘Indirect’ and the ‘fy_week’ fill set of ‘12’ and ‘13’) adding the fills for the unrepresented combinations 2728 and 2748 while eliminating the represented combinations 2735. That fill output 2738 then becomes the starting point for the second combination fill as exampled by 2763 in FIG. 27B. That second combination fill applies the second fill parameter cross join combination fill set 2785 (created in the manner previously exampled and conceptually exampled in FIG. 51A and FIG. 51B creating each of the fill sets and then doing a cross join of those fill sets) adding the fills for the unrepresented combinations 2768 from the combination fill set 2775 to the first double join outputs 2788 while eliminating the represented combinations 2765 and 2795. That fill output 2778 is then sorted by the function and populated in the cells ‘A1’ through ‘D11’ 2653 in FIG. 26A. The net result is the fill rows 2643 and 2673 added to the unfilled output.

FIG. 26B examples the application of a triple combination fill (employing the fill parameter 2628) to the functional formula 2618 in cell ‘A1’ 2636. This results in the triple combination filling as illustratively (abbreviated) exampled in FIG. 28. FIG. 28 examples starting with the unfilled function output 2822 which has two rows of values 2823. Our technology then applies the fill parameter triple cross join combination fill set 2865 (created in the manner previously exampled and conceptually exampled in FIG. 52A and FIG. 52B creating each of the fill sets and then doing a cross join of those three fill sets) adding the fills for the unrepresented combinations 2847 and 2877 while eliminating the represented combinations 2867 (represented in the unfilled values 2823). That fill output 2868 is then sorted by the function and populated in the cells ‘A1’ through ‘D17’ 2657 in FIG. 26B. The net result is the fill rows 2647 and 2687 added to the unfilled output to give the filled output 2657. As is exampled in FIG. 26A and FIG. 26B even though the same fields/ranges were utilized in both examples, two double combination fills can result in a very different results (2653 in FIG. 26A versus 2657 in FIG. 26B) than one triple combination fill employing the same fields/ranges/columns in our technology.

### Middle Combination Fills

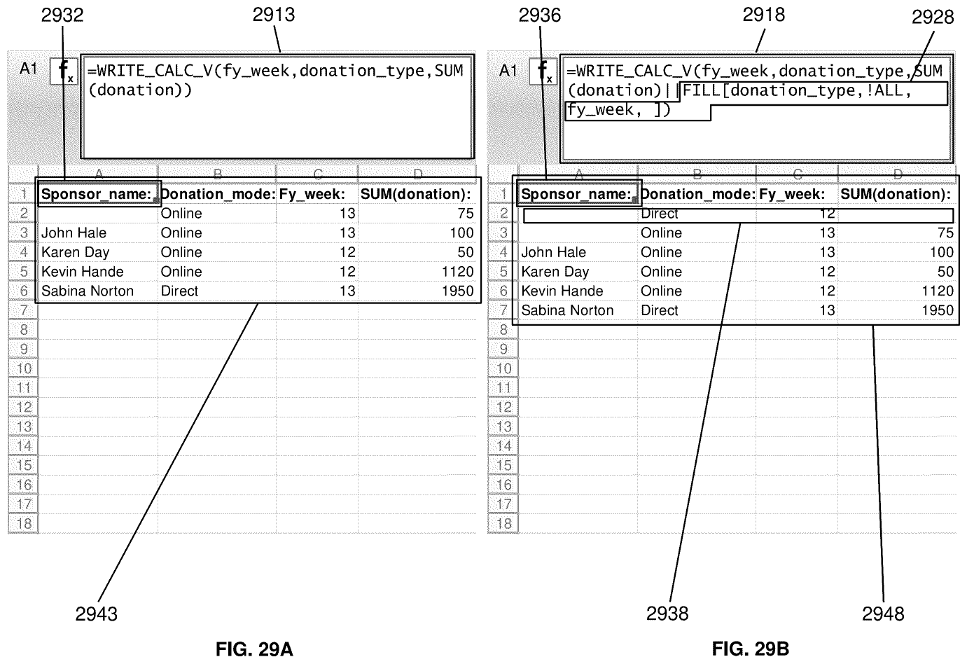

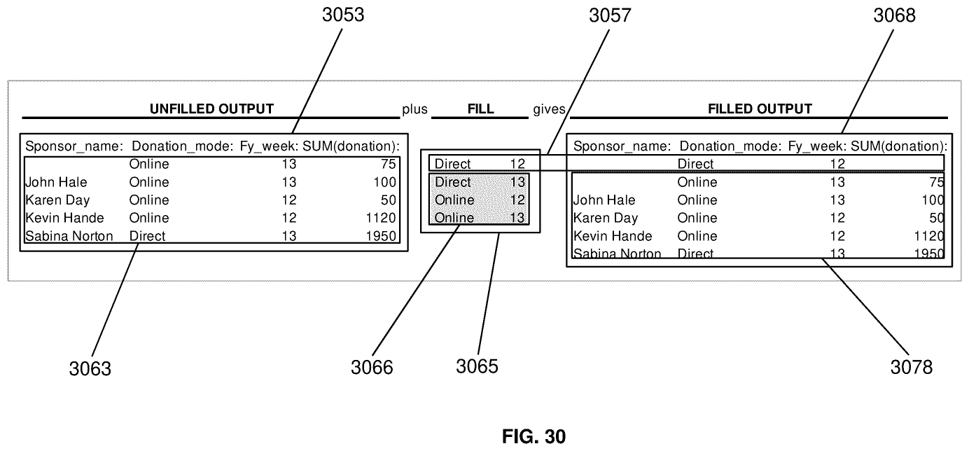

FIG. 29A through FIG. 30 examples our technology supporting a fill of fields/ranges that are not the first nor the last fields output by the prebuilt spreadsheet function. In this example the fill parameter is for the two fields/ranges output in the middle of the result, which in this situation gives one filled row 2938 in FIG. 29B with the first and that last columns empty (blank or populated with nulls). FIG. 29A examples the unfilled ‘WRITE_CALC_V’ functional formula 2913 for the cell ‘A1’ 2932 which populates the cells ‘A1’ through ‘D6’ 2943. FIG. 29B examples the combination filled ‘WRITE_CALC_V’ functional formula 2918 for the cell ‘A1’ 2936 which populates the cells ‘A1’ through ‘D7’ 2948. The fill parameter employs an explicit ‘!ALL’ fill set specifier value for the field/range ‘donation_type’ and an implicit/default all fill set specifier value for the field/range ‘fy_week. FIG. 30 examples in an illustrative abbreviated way starting with the unfilled function output 3053 which has five rows of values 3063. Our technology then applies the fill parameter double cross join combination fill set 3065 (created as conceptually exampled in FIG. 51A and FIG. 51B) adding the fills for the unrepresented combination 3057 while eliminating the represented combinations 3066 using instead the unfilled values 3078 to give the fill output 3068. That fill output 3068 is then sorted by the function and populated in the cells ‘A1’ through ‘D7’ 2948 in FIG. 29B.

### Middle Fill Versus a Triple Combination Fill

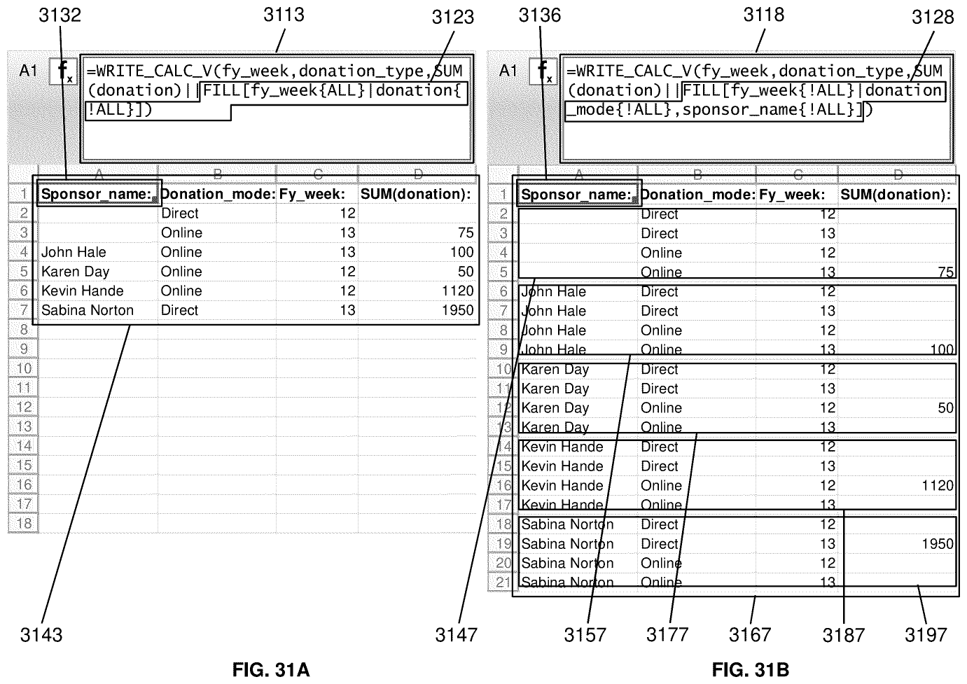

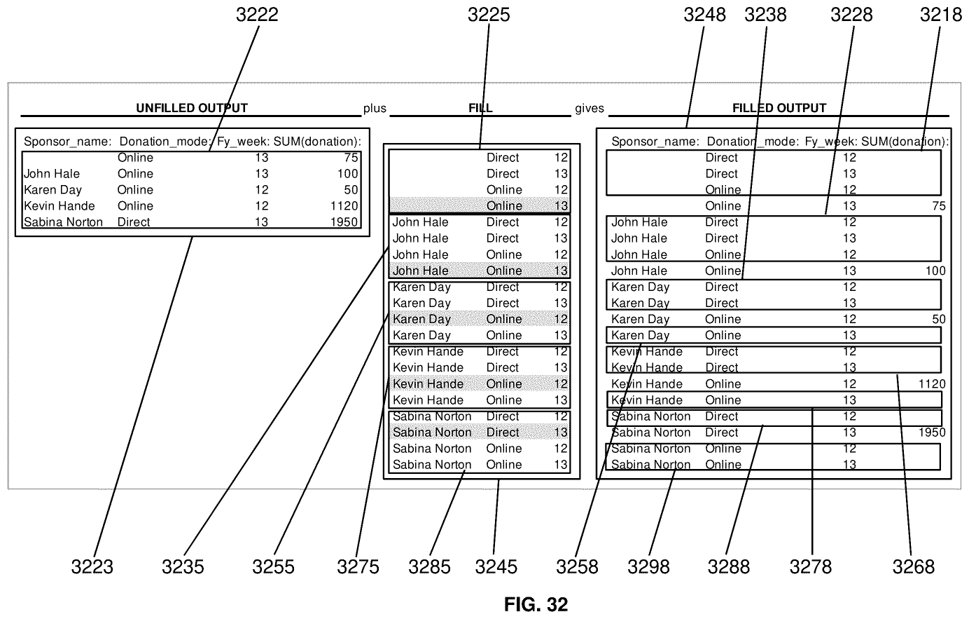

FIG. 31A through FIG. 32 examples our technology comparing the middle join of FIG. 29B (repeated as FIG. 31A for ease of comparison, although with a different fill parameter syntax) to a triple combination fill starting with the same two fill fields/ranges but then adding an additional fill field/range. FIG. 31A examples the middle combination filled ‘WRITE_CALC_V’ functional formula 3113 for the cell ‘A1’ 3132 which populates the cells ‘A1’ through ‘D7’ 3143 employing the fill parameter 3123. There is however a difference in the fill parameter syntax employed in FIG. 31A versus that in FIG. 29B. Both deliver the same outcome further exampling that our technology supports many different fill parameter syntaxes (as well as it supports many different locations of those fill parameters with different syntaxes). FIG. 31B examples the triple combination filled ‘WRITE_CALC_V’ functional formula 3118 for the cell ‘A1’ 3136 which populates the cells ‘A1’ through ‘D21’ 3167. Each fill field set employs an explicit ‘!ALL fill set specifier, although they could have employed any one of the different fill set types mentioned in FIG. 52A. It employs the triple cross join approach conceptually exampled in FIG. 52A and FIG. 52B. FIG. 32 examples in an illustrative abbreviated way starting with the unfilled function output 3222 which has five rows of values 3223. Our technology then applies the fill parameter triple cross join combination fill set 3245 (created in the way conceptually exampled in FIG. 52A and FIG. 52B) creating the five sets of fill combinations 3225, 3235, 3255, 3275, and 3285, one for each value of ‘sponsor_name’. Then it greys out/eliminates all represented combinations (in the unfilled results) and adds all the fills for the unrepresented combinations 3218, 3228, 3238, 3258, 3268, 3278, 3288, and 3298. That fill output 3248 is then sorted by the function and populated in the cells ‘A1’ through ‘D21’ 3167 in FIG. 31B. Where the triple cross join fill ends up with five sets (3147, 3157, 3177, 3187, and 3197) of filled outputs for each ‘Sponsor_name:’ value (including the blank/empty/null value).

### Application to Varied Function Types

Our combination filling technology applies to all forms of spreadsheet functions that output tables (i.e., rows and columns). Thus far we have utilized a narrow set of WRITE′ families of functions that generate a table of values to example the feature/functionality without the distraction of many different function types. We will now much more briefly example different types of ‘WRITE’ function situations and types of functions to further example the broader applicability of our combination fill technology.

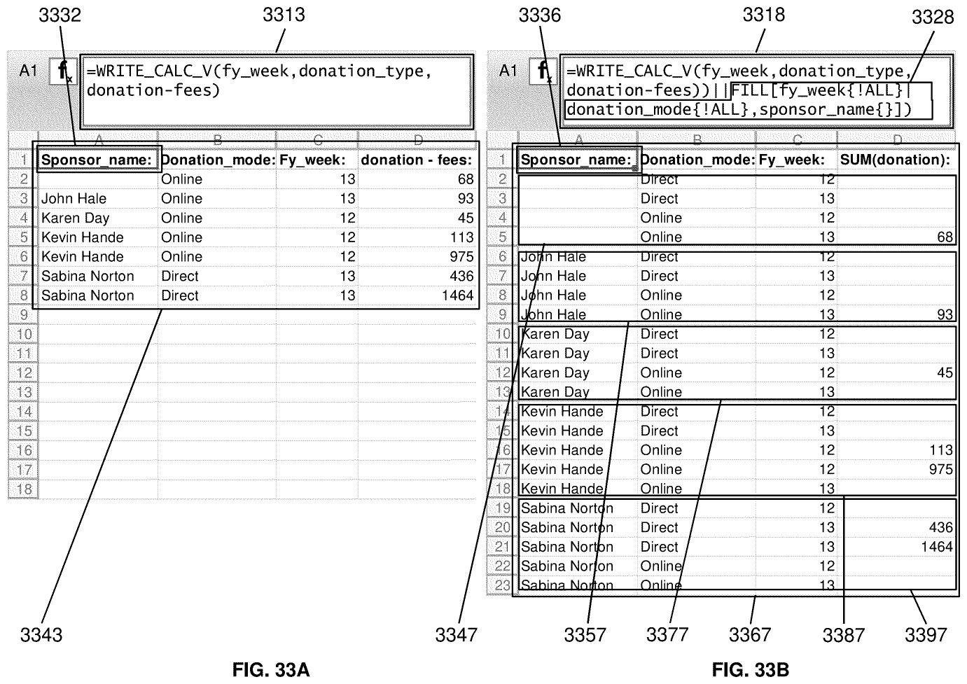

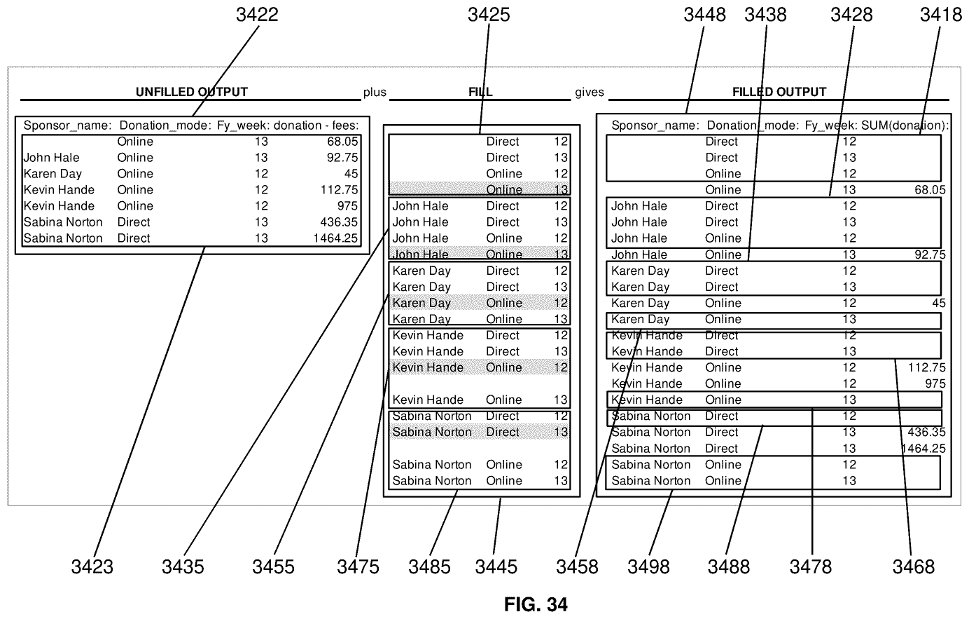

FIG. 33A through FIG. 34 example in our technology a triple combination fill of a ‘WRITE_CALC_V’ function executing an algebraic formula. FIG. 33A examples the unfilled ‘WRITE_CALC_V’ functional formula 3313 for the cell ‘A1’ 3332 which populates the cells ‘A1’ through ‘D8’ 3343. FIG. 33B examples the triple combination filled ‘WRITE_CALC_V’ functional formula 3318 for the cell ‘A1’ 3336 which populates the cells ‘A1’ through ‘D23’ 3367. The first two fill parameter field/range fill set specifiers employ a fill parameter with an explicit ‘!ALL and the third fill parameter field/range fill set specifier employ's an implicit/default all (‘ALL!’) shown by the empty curly brackets in this embodiment. Although the fill set specifiers could have employed any one of the different fill set types mentioned in FIG. 52A. The fill parameter 3328 employs the triple cross join approach conceptually exampled in FIG. 52A and FIG. 52B. FIG. 34 examples, in an illustrative abbreviated way, starting with the unfilled function output 3422 which has seven rows of values 3423. Our technology then applies the fill parameter triple cross join combination fill set 3445 (created in the way conceptually exampled in FIG. 52A and FIG. 52B) creating the five sets of fill combinations 3425, 3435, 3455, 3475, and 3485, one for each value of ‘sponsor_name’ (including the blank ‘sponsor_name’ 3425). Then it automatically greys out/eliminates all represented combinations and adds all the fills for the unrepresented combinations 3418, 3428, 3438, 3458, 3468, 3478, 3488, and 3498. That fill output 3448 is then sorted by the function and populated in the cells ‘A1’ through ‘D23’ 3367 in FIG. 33B. Where the triple cross join fill ends up with five sets (3347, 3357, 3377, 3387, and 3397) of filled outputs for each ‘Sponsor_name:’ value (including the blank/empty/null value).

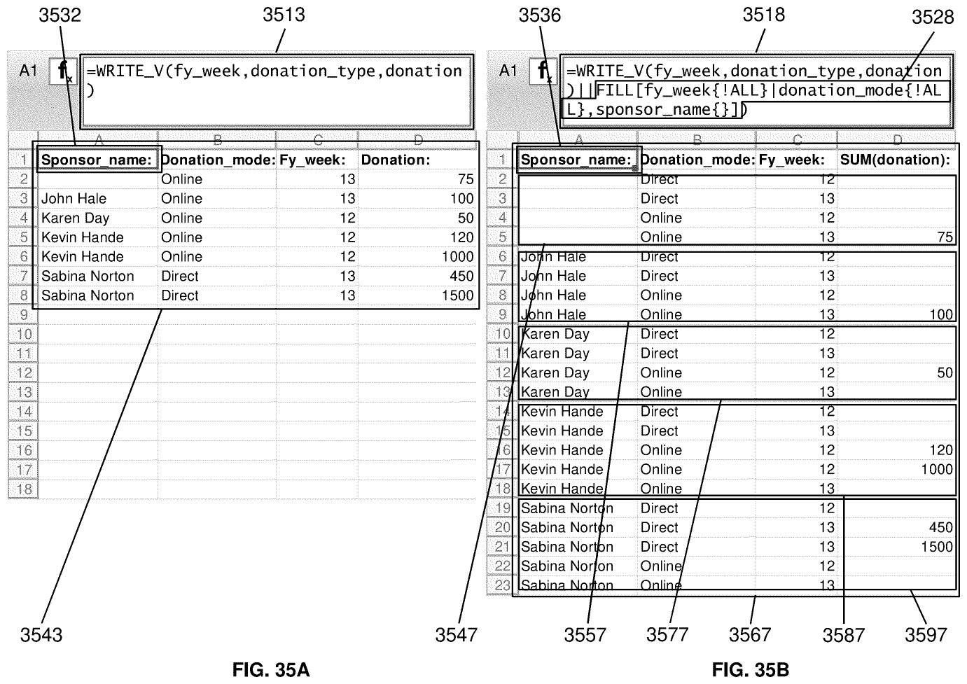

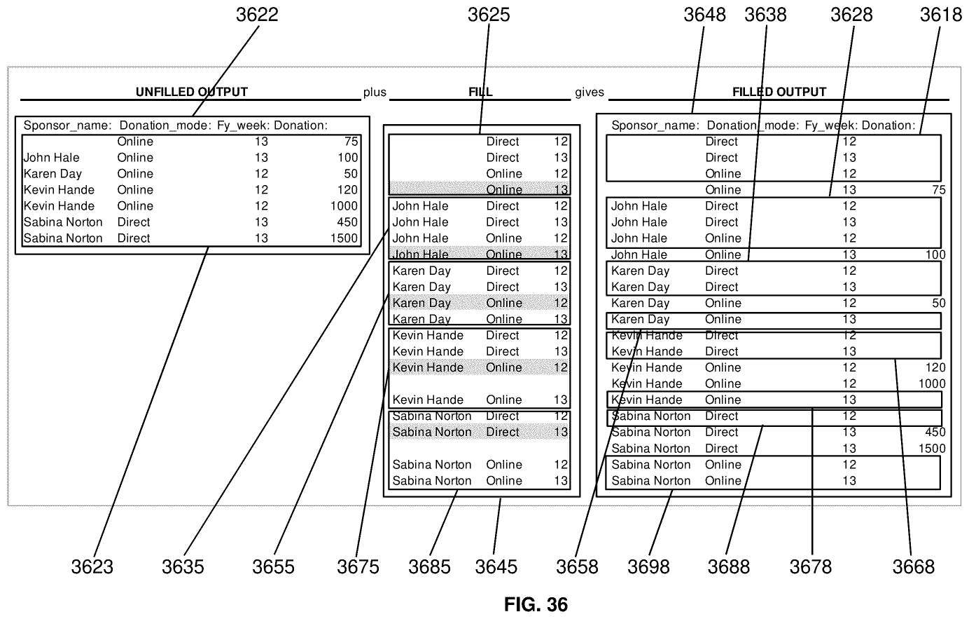

FIG. 35A through FIG. 36 examples a triple combination fill of a ‘WRITE_V’ function employing data from non-spreadsheet cell or spreadsheet cell sources (like any of our other example) creating a column order of the data that is then row sorted. FIG. 35A examples the unfilled ‘WRITE_V’ functional formula 3513 for the cell ‘A1’ 3532 which populates the cells ‘A1’ through ‘D8’ 3543. FIG. 35B examples the triple combination filled ‘WRITE_V’ functional formula 3518 for the cell ‘A1’ 3536 which populates the cells ‘A1’ through ‘D23’ 3567. The first two fill parameter field/range fill set specifiers employ a fill parameter with an explicit ‘!ALL and the third fill parameter field/range fill set specifier employ's an implicit/default all (‘ALL!’) shown by the empty curly brackets in this embodiment. Although they could have employed any one of the different fill set types mentioned in FIG. 52A. The fill parameter 3528 employs the triple cross join approach conceptually exampled in FIG. 52A and FIG. 52B. FIG. 36 examples in an illustrative abbreviated way starting with the unfilled function output 3622 which has seven rows of values 3623. Our technology then applies the fill parameter triple cross join combination fill set 3645 (created in the way conceptually exampled in FIG. 52A and FIG. 52B) creating the five sets of fill combinations 3625, 3635, 3655, 3675, and 3685, one for each value of ‘sponsor_name’ (including the blank ‘sponsor_name’ 3625). Then our technology greys out/eliminates all represented combinations (in the unfilled result) and adds all the fills for the unrepresented combinations 3618, 3628, 3638, 3658, 3668, 3678, 3688, and 3698. That fill output 3648 is then sorted by the function and populated in the cells ‘A1’ through ‘D23’ 3567 in FIG. 35B. Where the triple cross join fill ends up with five sets (3547, 3557, 3577, 3587, and 3597) of filled outputs for each ‘Sponsor_name:’ value (including the blank/empty/null value).

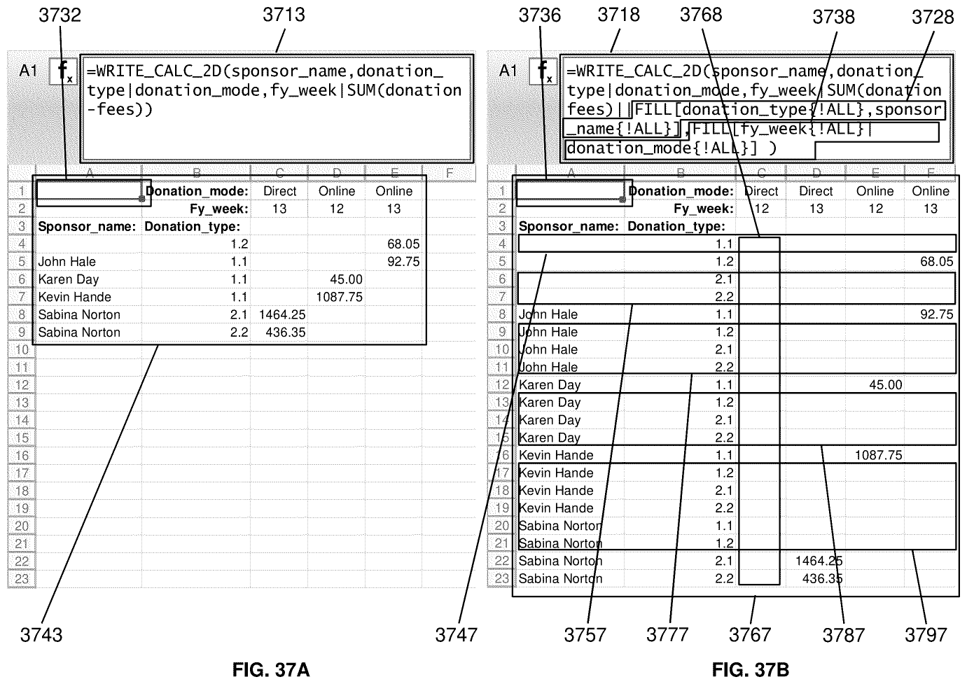

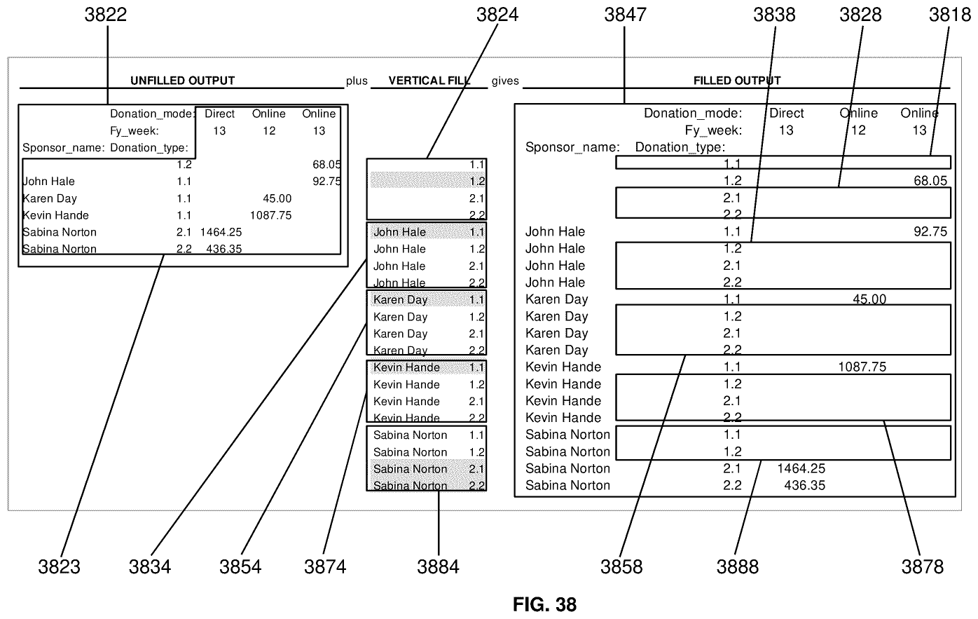

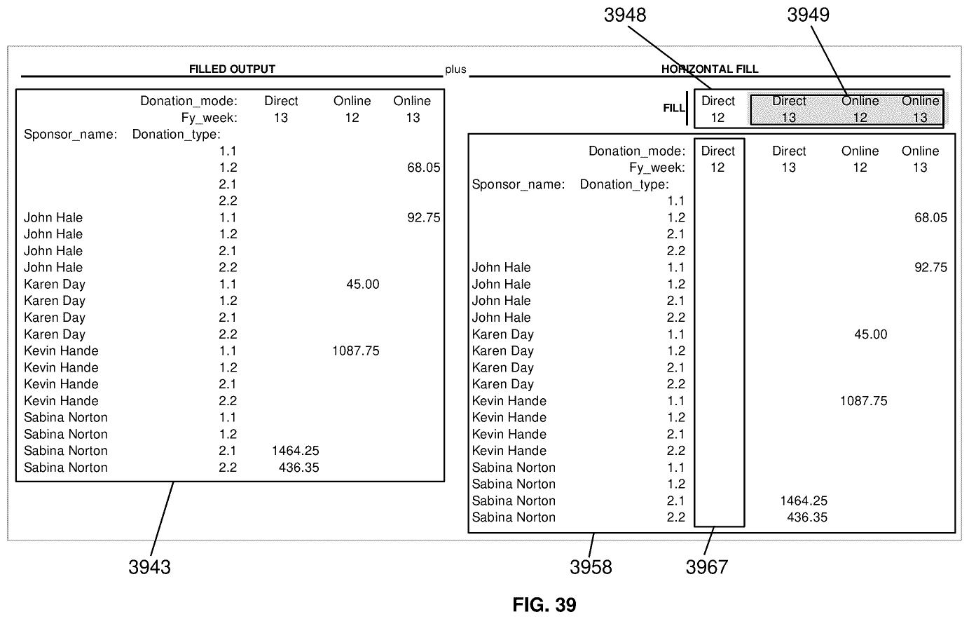

FIG. 37A through FIG. 39 examples two separate double combination fills of a ‘WRITE_CALC_2D’ two-dimensional function organizing and potentially filtering/constraining data from non-spreadsheet cell or spreadsheet cell sources (if that argument group where populated). FIG. 37A examples the unfilled ‘WRITE_CALC_2D’ functional formula 3713 for the cell ‘A1’ 3732 which populates the cells ‘A1’ through ‘E9’ 3743. FIG. 37B examples a two separate double combination filled ‘WRITE_CALC_2D’ functional formula 3718 for the cell ‘A1’ 3736 which populates the cells ‘A1’ through ‘F23’ 3767 having filled both the vertical and horizontal headings. FIG. 37B examples the application of two separate combination fills (employing two fill parameters 3728 and 3738) to that functional formula. This results in two rounds of filling as illustratively (abbreviated) exampled in FIG. 38 and FIG. 39. FIG. 38 examples the first fill, which is for the vertical headings, starting with the unfilled function output 3822 which has six rows of values and three columns of values 3823. Our technology then applies the first fill parameter cross join combination fill set 3884 (created in the ways previously exampled and conceptually exampled in FIG. 51A and FIG. 51B) creating the five sets of fill combinations 3824, 3834, 3854, 3874, and 3884, one for each value of ‘sponsor_name’ (including the blank ‘sponsor_name’). Then our technology greys out/eliminates all represented combinations (in the unfilled result) and adds all the fills for the unrepresented combinations 3818, 3828, 3838, 3858, 3878, and 3888. That fill output 3847 then becomes the starting point for the second combination fill as exampled by 3943 in FIG. 39. That second combination fill applies the second fill parameter cross join combination fill set 3948 (created in the ways previously exampled and conceptually exampled in FIG. 51A and FIG. 51B) adding the fills for the unrepresented combination 3967 from the combination fill set 3948 while eliminating the represented combinations 3949. That fill output 3958 is then sorted by the function and populated in the cells ‘A1’ through ‘F23’ 3767 in FIG. 37B. The net result is the fill rows 3747, 3757, 3777, 3787, and 3797 and the filled column 3768 added to the unfilled output.

### Application to FILTER Function

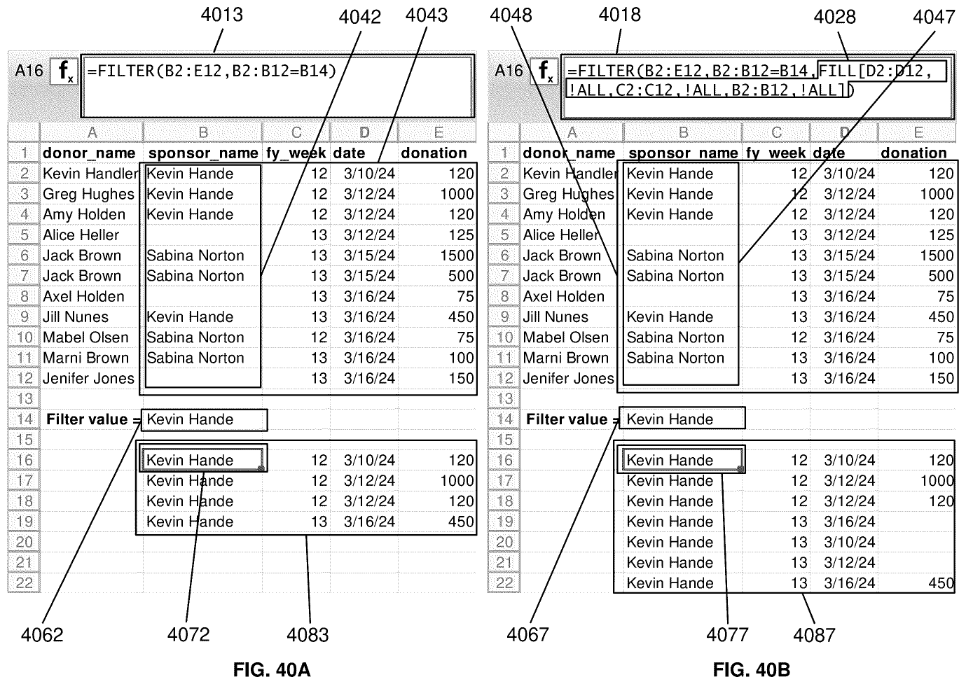

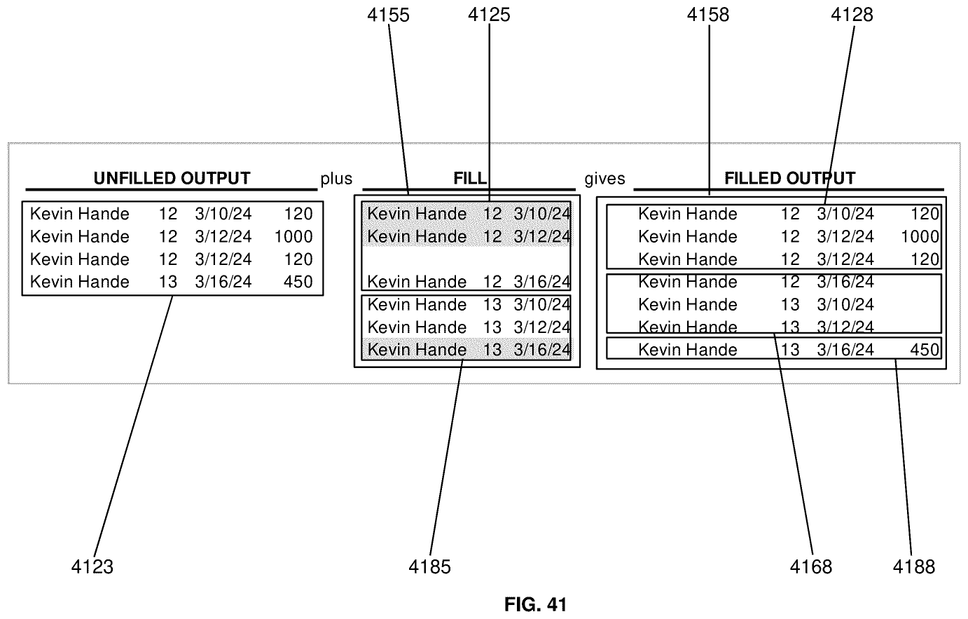

FIG. 40A through FIG. 41 examples a triple combination fill of a ‘FILTER’ function with our technology. FIG. 40A examples the unfilled ‘FILTER’ functional formula 4013 for the cell ‘B16’ 4072 which populates the cells ‘B16’ through ‘E19’ 4083. The ‘FILTER’ formula works as it does in the other spreadsheets (e.g., Microsoft Excel and Google Sheets) in this example filtering the values in cells ‘B2’ through ‘E12’ 4043 using the filter value ‘Kevin Hande’ in cell ‘B14’ 4062 filtering on the values in the range ‘B2:B12’ 4042. FIG. 40B examples the triple combination filled ‘FILTER’ functional formula 4018 for the cell ‘B16’ 4077 which populates the cells ‘B16’ through ‘E22’ 4087. All three of fill parameter field/range fill set specifiers employ a fill parameter with an explicit ‘!ALL although they could have employed any one of the different fill set types mentioned in FIG. 52A. The fill parameter 4028 employs the triple cross join approach conceptually exampled in FIG. 52A and FIG. 52B. The fill parameter fields/ranges use cell range 4048 filtering on the value ‘Kevin Hande’ in cell ‘B14’ 4067 filtering on the values in the range ‘B2:B12’ 4047 as does the regular ‘FILTER’ formula. FIG. 41 examples in an illustrative abbreviated way starting with the unfilled function output 4123, which has four rows of values. Our technology then applies the fill parameter triple cross join combination fill set 4155 (created in the way conceptually exampled in FIG. 52A and FIG. 52B) creating the two sets of fill combinations 4125 (which has an empty row/line for alignment purposes with the filled output) and 4185, one for each value of ‘fy_week’ (i.e., ‘12’ and ‘13’) because the filtering leaves only one ‘sponsor_name’ value ‘Kevin Hande’. Then it greys out/eliminates all represented fill combinations retaining the unfilled values 4128 and 4188 and adds all the fills for the unrepresented combinations 4168. That fill output 4158 can then be ordered different ways and populated in the cells ‘B16’ through ‘E22’ 4087 in FIG. 40B. With end result being there are a full set of the ‘date’, ‘fy_week’, and ‘sponsor_name’ remaining combinations in the filtered results. Those results could be altered by the user specifying different fill parameter fill sets as per our other examples herein.

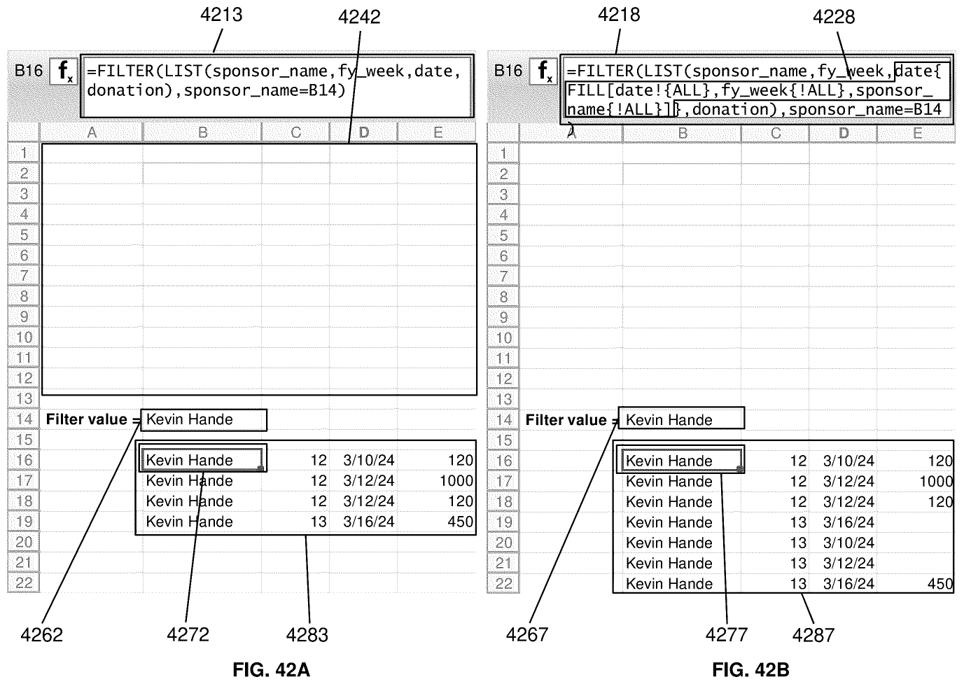

FIG. 42A and FIG. 42B examples a triple combination fill of a ‘FILTER’ function like that in FIG. 40B except using our formulaic data and our LIST function. It also employs a different fill parameter location and syntax. FIG. 42A examples the unfilled ‘FILTER’ functional formula 4213 for the cell ‘B16’ 4272 which populates the cells ‘B16’ through ‘E19’ 4283. The ‘FILTER’ formula works as it does in the other spreadsheets (e.g., Microsoft Excel and Google Sheets) except using our formulaic data combined with our LIST function to supply the data which is filtered. That data in this example is in some external source like those exampled in FIG. 53A and FIG. 53B not the cells ‘B1’ through ‘E12’ as it was in FIG. 40A. The ‘LIST function populates the multiple values of ‘sponsor_name,fy_week,date,donation’ into the first argument of the ‘FILTER’ function. It filters those values using the filter value ‘Kevin Hande’ in cell ‘B14’ 4262 filtering on the values in ‘sponsor_name’ to give the values in cells ‘B16’ through ‘E19’ 4283. But other than the location of the data and the use of our formulaic data FIG. 40A and FIG. 42A do the same thing giving the same results (4083 in FIG. 40A and 4283 in FIG. 42A). FIG. 42B examples the triple combination filled ‘FILTER’ functional formula 4218 for the cell ‘B16’ 4277 which populates the cells ‘B16’ through ‘E22’ 4287. In this embodiment the fill parameter 4228 is located within the curly brackets of the ‘date’ field and the fill set specification for each of the three fill fields is specified within the curly brackets for each of those fields. All three of fill parameter field/range fill set specifiers employ a fill parameter with an explicit ‘!ALL, although they could have employed any one of the different fill set types mentioned in FIG. 52A. The fill parameter 4228 employs the triple cross join approach conceptually exampled in FIG. 52A and FIG. 52B. The ‘FILTER’, like in FIG. 32A, uses the LIST function to set up the filter range and then uses the ‘sponsor_name’ field filtering on the value ‘Kevin Hande’ in cell ‘B14’ 4267 (‘sponsor_name=B14’) to deliver the values in ‘B16’ through ‘E22’ 4287 for the formula 4218 containing the fill argument 4228 in cell ‘B14’ 4267. For brevity's sake the abbreviated illustrative sets automatically done by our fill parameter have been omitted as they are identical to those in FIG. 41 except employing the formulaic data fields rather than the cell ranges for the data. Note our ‘LIST’ function allows the four different formulaic data fields to be populated in the first argument of the ‘FILTER function. The end result 4287 is the same as in FIG. 40B 4087 with a full set of the ‘date’, ‘fy_week’, and ‘sponsor_name’ combinations in the filtered results (recognizing that the FILTER function reduced the ‘sponsor-name’ values to only ‘Kevin Hande’. Those results could be altered by the user specifying different fill parameter fill sets as per our other examples herein.

### Application to SORTBY Function

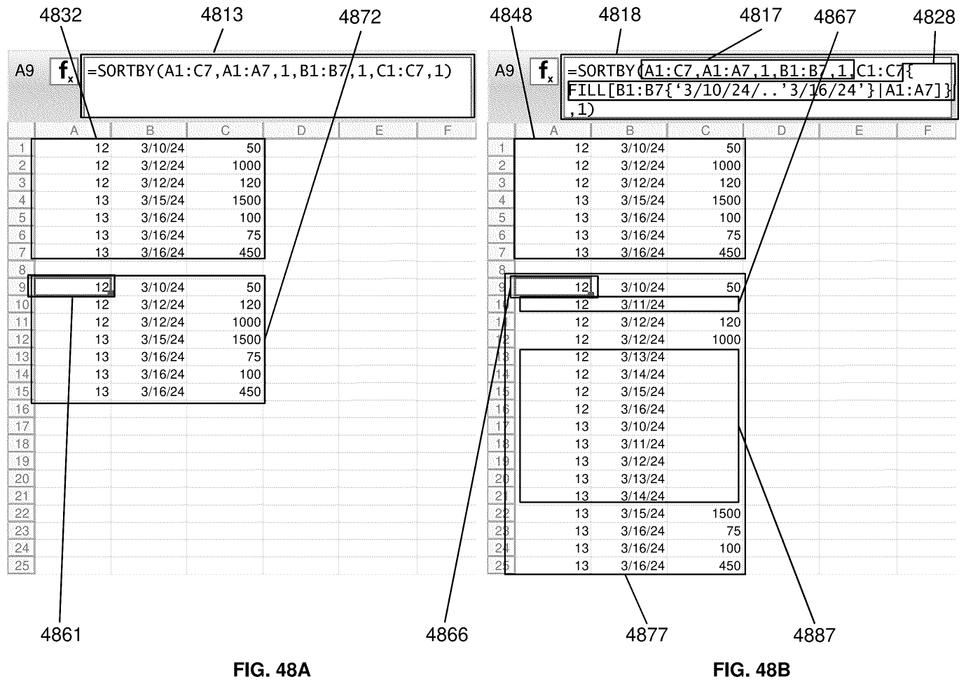

FIG. 48A through FIG. 50 examples a combination fill of a ‘SORTBY’ function using our technology. FIG. 48A examples the unfilled ‘SORTBY’ functional formula 4813 for the cell ‘A9’ 4861 which populates the cells ‘A9’ through ‘C15’ 4872. The ‘SORTBY’ formula works as it does in the other spreadsheets (e.g., Microsoft Excel and Google Sheets) in this example sorting the values in cells ‘B1’ through ‘C7’ 4832 in ascending order first by column ‘A’, then column ‘B’, and finally column ‘C’. FIG. 48B examples the triple combination filled ‘SORTBY’ functional formula 4818 for the cell ‘A9’ 4866 which populates the cells ‘A9’ through ‘C25’ 4877. The fill parameter 4828 is positioned within the ‘C1:C7’ field/range employing curly brackets as the range modifier for adding the fill parameter. The fill parameter employs an argument structure where the first fill field/range is separated from the one or more second fill range/field by a bar (‘|’) with the fill set specifier of a date range ‘{‘3/10/2024’ . . . ‘3/16/2024’}′ for the first field/range ‘B1:B7’ fill set and an implicit all fill set specifier for the second field/range ‘A1:A7’. Note our technology supports any of the fill set specifiers (e.g., default, unique values, all values, list, and range) applicable to the fill field/range data types described herein for use in the ‘SORTBY’ function as it does for any of the applicable spreadsheet prebuilt functions (e.g., the WRITE families, FILTER, SORT, SORTBY, and TRANSPOSE). The result is the filling of the rows 4867 and 4887 in the ‘SORTBY function output 4877.

Note in FIG. 48B the fill parameter 4828 is a specialized square bracket fill parameter with and argument group syntax. However, our technology supports it the fill parameter being populated many different ways. For example, it could be a spreadsheet function with the typical parentheses, not square brackets, and with different argument syntaxes (e.g., repeating pairs of data fields and fill sets. In FIG. 48B the fill parameter 4828 has also made the last column range used in the fill the first FILL argument and the first column used in the SORTBY formula and the second data range in the FILL argument (e.g., ‘B1:B7’ comes after ‘A1:A7’ in the ‘SORTBY range and sort order 4817 but ‘B1:B7 comes before ‘A1:A7’ in the FILL argument 4828. However, our technology supports any order of the data field/ranges within the FILL argument or arguments, so the FILL argument order could be reversed.

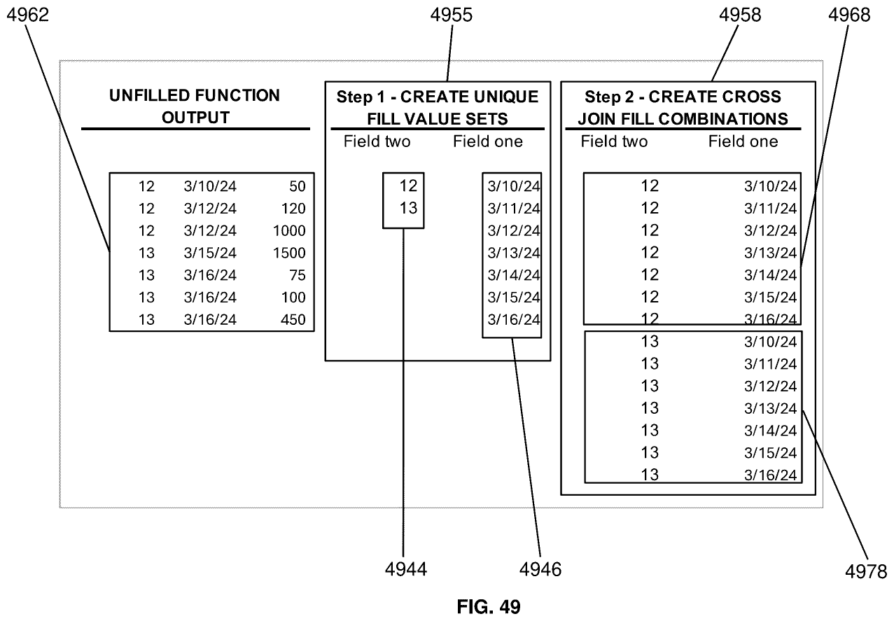

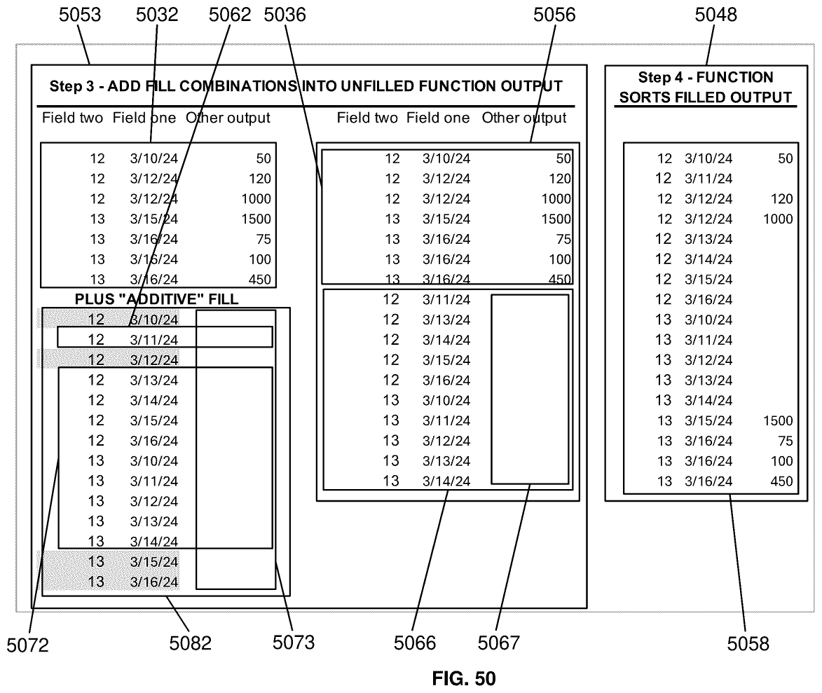

FIG. 49 and FIG. 50 illustratively example the steps employed by our technology to deliver the results in cell ‘A9’ through ‘C25’ 4877 in FIG. 48B. It starts with Step 1′ 4955 in FIG. 49 creating the fill lists for the fields/ranges involved in the filling of the unfilled values 4962. In this example the ‘Field one’ fill set values 4946 are the range ‘3/10/2024, 3/11/2024. 3/12/2024, 3/13/2024, 3/15/2024, and 3/16/2024’ specified by the user (‘‘3/10/2024’ . . . ‘3/16/2024’’) within the curly brackets for that field/range fill while the ‘Field two’ fill set values 4944 are the all the values (12, 13) for that field/range. ‘Step 2’ 4958 then creates cross joined combinations of those individual fields/range fill sets as exampled for ‘Field two’ ‘12’ 4968 and ‘Field one’ ‘13’ 4978 in this example. The cross join also works as illustratively exampled in FIG. 51A giving the equivalent of the illustrative result in FIG. 51B. ‘Step 3’ 5053 in FIG. 50 then adds any otherwise not present combination fill set values 5062 and 5072 to the unfilled result 5032 (4962 in FIG. 49) eliminating any fill values already present (grayed out rows in 5082) in the unfilled values (5032) as shown in output 5066 added to the unfilled output 5036. It also delivers the non-fill outputs ‘Other output’ values (5067 which came from 5073) with blanks, nulls, or empty outputs. Then the normal sorting of the results by the ‘SORTBY’ function kicks in as exampled in ‘Step 4’ 5048 to give the results 5058 returned to cells ‘A9’ through ‘C25’ 4877 in FIG. 48B.

For brevity's sake we have not exampled our combination fill technology working for the SORT function as that is just a simpler version of the SORTBY function and works in a similar manner for sorting and for our combination filling. Our technology is applicable to other spreadsheet functions that deliver multiple row or multiple column results (e.g., TRANSPOSE) with definable relationships between the rows or the columns where those relationships can be set up in a fill parameter with combination fill fields/ranges with default or user specified fill sets.

In the interest of conciseness, the combinations of fill parameter features (e.g., syntaxes and locations) disclosed in this application are not individually enumerated and are not repeated with each of the applicable prebuilt spreadsheet functions. The reader will understand how features identified in this section can readily be combined with the different prebuilt spreadsheet functions. We will therefore move on to describing one of many example computer systems that can be used for our technology.

### Computer System

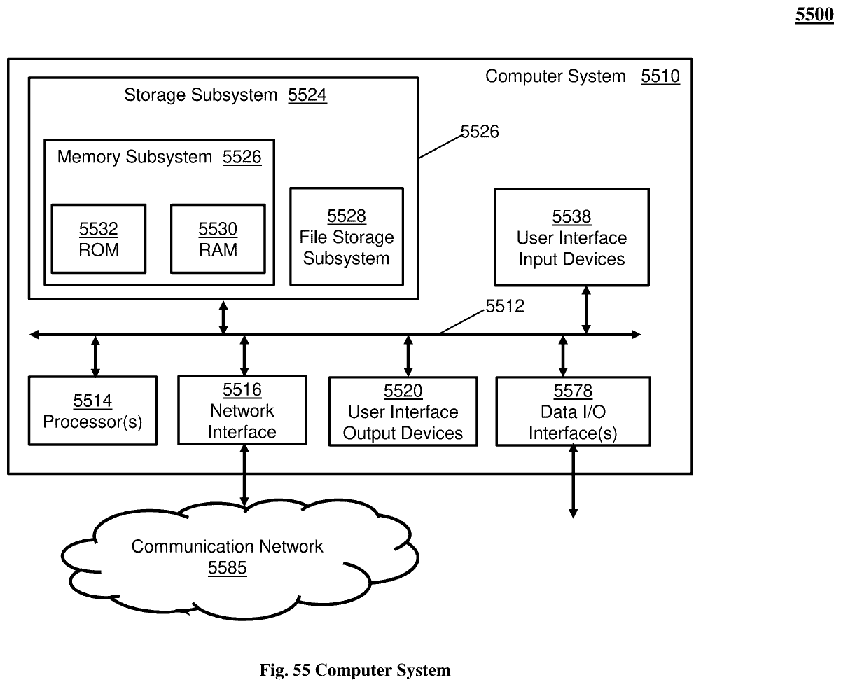

FIG. 55 is a block diagram of an example computer system, according to one implementation. Computer system 5510 typically includes at least one processor 5514 which communicates with a number of peripheral devices via bus subsystem 5512. These peripheral devices may include a storage subsystem 5524 including, for example, memory devices 5526 and a file storage subsystem 5528, user interface input devices 5538, user interface output devices 5520, data I/O interface(s) 5578, and a network interface subsystem 5516. The input and output devices allow user interaction with computer system 5510. Network interface subsystem 5516 provides an interface to outside networks, including an interface to communication network 5585, and is coupled via communication network to corresponding interface devices in other computer systems or in the cloud and usable for cloud applications.

User interface input devices 5538 may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 5510 or onto communication network.

User interface output devices 5520 may include a display subsystem, a printer, a fax machine, or non-visual displays such as audio output devices. The display subsystem may include a touch screen, a flat-panel device such as a liquid crystal display (LCD), a projection device, a cathode ray tube (CRT), or some other mechanism for creating a visible image. The display subsystem may also provide a non-visual display such as via audio output devices. In general, use of the term “output device” is intended to include all possible types of devices and ways to output information from computer system 5510 to the user or to another machine or computer system.

Storage subsystem 5524 stores programming and data constructs that provide the functionality of some or all of the modules and methods described herein. These software modules are generally executed by processor 5514 alone or in combination with other processors.

Memory 5526 used in the storage subsystem 5524 can include a number of memories including a main random-access memory (RAM) 5530 for storage of instructions and data during program execution and a read only memory (ROM) 5532 in which fixed instructions are stored. A file storage subsystem 5528 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 5528 in the storage subsystem 5524, or in other machines accessible by the processor.

Bus subsystem 5512 provides a mechanism for letting the various components and subsystems of computer system 5510 communicate with each other as intended. Although bus subsystem 5512 is shown schematically as a single bus, alternative implementations of the bus subsystem may use multiple busses.

Computer system 5510 can be of varying types including a workstation, server, computing cluster, blade server, server farm, or any other data processing system or computing device. Due to the ever-changing nature of computers and networks, the description of computer system 5510 depicted in FIG. 55 is intended only as one example. Many other configurations of computer system 5510 are possible having more or fewer components than the computer system depicted in FIG. 55.

### Some Particular Implementations

Some particular implementations and features are described in the following discussion. For brevity's sake, much of the feature/functionality of the combination fill technology was exampled for our ‘WRITE’ families of spreadsheet prebuilt table generation functions, which we have also called table generation functions here. Those functions, under various function names, are detailed in our U.S. application Ser. No. 16/191,402 titled, “Methods and Systems for Connecting a Spreadsheet to External Data Sources with Ordered Formulaic Specification of Data Retrieved,” filed 14 Nov. 2018, now U.S. Pat. No. 11,36,929, issued 15 Jun. 2021, U.S. application Ser. No. 17/374,901 titled “Method and System for Improved Ordering of Output from Spreadsheet Analytical Functions,” filed 13 Jul. 2021, U.S. application Ser. No. 17/903,934 titled “Method and System for Improved 2d Ordering of Output from Spreadsheet Analytical Functions,” filed 6 Sep. 2022, and U.S. application Ser. No. 18/586,370 titled “Method and System For Repeat 2d Ordering of Output From Spreadsheet Analytical Functions.” However, the feature/functionality exampled for those functions is applicable to the other spreadsheet prebuilt functions that populate tables of data (e.g., rows and columns of data with or without headings).

One implementation of our technology applicable to all prebuilt spreadsheet functions that populate a table of data composed of at least one first data field/range and at least one second data field/range. Then with the addition of at least one fill parameter specifying a first data field/range and at least one second data field/range, each with a user specified or application default fill set of values. Those fill sets of values are then cross joined (as exampled in FIG. 51A through FIG. 52B) to create a combination fill set of values that are used to fill the unfilled prebuilt spreadsheet function output. That is done by adding the combination fill set values which are not represented in the unfilled prebuilt spreadsheet function output to the output as part of the fill parameter filled prebuilt spreadsheet output as exampled in FIG. 5A through FIG. 8, FIG. 43A through FIG. 44, and FIG. 48A through FIG. 50 for prebuilt spreadsheet formulas outputting table results with only the first and the second fields/ranges. This implementation supports outputs including other fields/ranges not included in the fill parameter and/or outputs including multiple second fields/ranges with specific examples to follow.

### Some Particular Implementations—Different Prebuilt Functions

As we already discussed our combination fill technology is applicable to all prebuilt spreadsheet functions that populate a table of results with at least two identifiable fields/ranges. One important family (set) of prebuilt spreadsheet functions is the table generation functions (e.g., WRITE family of functions) previously mentioned. That family is distinct from many other table populating functions in that it gives the user the ability to decide the field/range content of the output without any pre-set order defined by the data source. It was the subject of many of our examples as to its applicability for our combination filling technology. As long as these functions are used with at least two defined fields/ranges that are then used in our combination fill parameter, then our technology is totally applicable to them as exampled in FIG. 5A through FIG. 39, and FIG. 43A through FIG. 47.

Another classification of applicable prebuilt spreadsheet table populating function for our combination fill technology is what we call the spreadsheet table transforming prebuilt functions (e.g., FILTER, SORT, SORTBY, and TRANSPOSE). Each of these functions typically takes a data source with a pre-set order (e.g., in-cell range or table) and performs some transformation of it (e.g., filters it, sorts it, or transposes it) into a new set of cells without changing the data from which it was populated. As long as these functions are used with at least two defined fields/ranges that are then used in our combination fill parameter, then our technology is totally applicable to them as exampled in FIG. 40A through FIG. 42B, and FIG. 48A through FIG. 50.

### Some Particular Implementations—More Outputs or Second Fields/Ranges

Implementations of our combination fill technology support additional table outputs of fields/ranges and/or calculations done with fields/ranges which are populated with blank, null, or empty values for the filled rows and/or columns of the table output as exampled in as exampled in FIG. 9A through FIG. 16, FIG. 33A through FIG. 36, FIG. 40A through FIG. 42B, and FIG. 48A through FIG. 50.

Implementations of our combination fill technology support multiple second fields/ranges included in the fill parameter so that multiple cross joins are performed as conceptually exampled in FIG. 52A, and FIG. 52B and actually exampled in FIG. 45A through FIG. 47, FIG. 25A through FIG. 28 and FIG. 31B through FIG. 36. Note FIG. 25A through FIG. 28 compares the difference between one double combination fill, where there is one fill parameter with one first fill field/range and two second fill fields/ranges, versus involving the same three fields/ranges in two separate fill parameters.

### Some Particular Implementations—Fill Parameter Locations and Argument Types

Implementations of our combination fill technology support a broad range of fill parameter locations within the prebuild spreadsheet table populating function formula. One implementation supports the fill parameter added as an optional argument to the prebuilt spreadsheet table populating function as exampled in FIG. 5A through FIG. 19B, FIG. 23A through FIG. 41, and FIG. 43A through FIG. 47. Another implementation supports the fill parameters inclusion with the first or second field/range regular prebuilt spreadsheet table populating function arguments that populate those values as exampled in FIG. 20A through FIG. 22B, FIG. 42A and FIG. 42B, and FIG. 48A through FIG. 50.

Implementations of our combination fill technology support a broad range of fill parameter argument syntaxes/structures. One implementation, that works with many of the other implementations herein, support the fill parameters inclusion via a fill prebuilt function as exampled in FIG. 22A and FIG. 22B. That prebuilt function employed the function name ‘FILL’ but could have used any other name not already used by a spreadsheet prebuilt function. One implementation supports fill parameter arguments which have separate arguments for each first and second field/range and their respective fill set specifiers as exampled in FIG. 15A through FIG. 21, FIG. 23B, FIG. 25A through FIG. 30, and FIG. 40A through FIG. 41. Another implementation supports fill parameter arguments which have separate arguments for each first and second field/range and those first and second field/range arguments contain their fill set specifiers or nothing if employing the default fill set as exampled in FIG. 5A through FIG. 14, FIG. 24A and FIG. 24B, FIG. 31A through FIG. 39, and FIG. 42A through FIG. 50.

### Some Particular Implementations—Fill Set Values

Implementations of our combination fill technology support a broad range of fill set values, some implicit or default, many user set, and some only applicable to certain data types. One implementation supports the fill set values being the complete set of values for that data field/range as described by ‘All the data field/range values’ in FIG. 51A and FIG. 52A. Another implementation or variant of the previous implementation supports the fill set values being the complete set of unique (distinct) values for that data field/range as described by ‘All the unique data field/range values’ in FIG. 51A and FIG. 52A and exampled as a default in FIG. 5A through FIG. 6, FIG. 17B for ‘donation_mode’ with the empty argument (‘,]’), FIG. 33B for ‘sponsor_name’ with the empty curly brackets (‘{ }’), and user specified using ‘ALLU’ in FIG. 9A through FIG. 11, and ‘!ALL’ in FIG. 15A through FIG. 16. Another implementation or variant of the previous implementations supports the fill set values being subject to limitation by the prebuilt spreadsheet table populating function data field/range value constraint/filter as exampled in FIG. 25A through FIG. 25C. This constraining/filtering of the fill set can be limited to default and fills specifying variants of all the field/range values (e.g., all values or all unique values) or can be applied to users specified ranges or lists.

Most of our implementations of our combination fill technology support user specification of the fill set values. Those fill sets can be the “all” or “unique all” set of values for the field/range or can be a very different set of values. Users can specify ranges with automatic incrementing by one between the highest and lowest values specified for the range for date and integer fill fields/ranges as exampled in FIG. 7A through FIG. 8, FIG. 17A and FIG. 17B, and FIG. 19A. Users can specify a fill set via a list in our technology as exampled in FIG. 43A through FIG. 44, FIG. 19B, and FIG. 22B. They can also indirectly specify a fill set via a list from our LIST function, our POPUP (also named DROPDOWN_MANY) function (subject of U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023) or our spreadsheet prebuilt functions (e.g., INPUT_RANGE and INPUT_MULTIPLE) and spreadsheet capabilities (e.g., multi-value validation values and range) in U.S. Provisional Application No. 63/622,515, titled “Methods and Systems for a Family of Dual Entry Spreadsheet Functions, Improved Spreadsheet Validations, and Partial Locking of Spreadsheet Functions and Cell Capabilities,” filed 18 Jan. 2024 via a cell reference as exampled in FIG. 23A, and FIG. 23B. Our technology also supports, as previously described, a fill set provided by referencing a range of cells that collectively hold more than one value used to create the fill set. So, the ‘A1’ cell 2329 referenced in FIG. 23B could instead have been a range of cells holding text values.

### Some Particular Implementations—Fill Field/Range Data Types

Implementations of our combination fill technology support all the date, integer, real, text, and Boolean data types in either the first or the second fill fields/ranges as has been exampled and discussed herein.

### Some Particular Implementations—More Complicated Combination Fills

Implementations of our combination fill technology support more complicated combination fills. One such implementation is supporting two separate combination fills within the same table populating function as exampled in FIG. 37A through FIG. 39. These separate combination non-overlapping fills can be on separate dimensions (horizontal and vertical) as in FIG. 37A through FIG. 39 or two separate combination fills on the same dimension (either horizontal or vertical). Implementations of our combination fill technology also support two separate but overlapping fills where a second field/range in one fill parameter is a first field/range in another fill parameter as exampled in FIG. 26A, FIG. 27A, and FIG. 27B.

### Some Particular Implementations—Other Prebuilt Table Populating Function Impacts

Implementations of our combination fill technology do not impact the sorting of the prebuilt table populating function other than adding more rows or columns of data to sort as exampled by many of the examples herein. Implementations do not impact the calculations done by any of the prebuilt table population function as exampled in FIG. 12A through FIG. 34 and FIG. 37A through FIG. 39. Implementations of our combination fill technology do not impact the filtering of the unfilled values in the examples herein but can result in the filtering of the prebuilt table populating function not filtering/constraining the values of the fills.

### Other Implementations

Implementations of our combination fill technology non-transitory computer readable storage medium storing instructions executable by a processor to perform any of the methods described above. Yet other implementations may include a system including memory and one or more processors operable to execute instructions, stored in the memory, to perform any of the methods described above.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following clauses and claims.

### CLAUSES

### Other Implementations

1. A non-transitory computer readable memory, the memory impressed with computer instructions that, when executed on hardware, cause the hardware to carry out the method of any of claims 1 through 25.

2. A system including processing hardware coupled to memory, the memory impressed with computer instructions that, when executed, cause the hardware to carry out the method of any of claims 1 through 25.

We claim as follows:

1. A method of applying a fill parameter for a prebuilt spreadsheet table populating function that fills first and second field combinations not otherwise present in unfilled output of the first and second fields from the prebuilt spreadsheet table function, including:
a spreadsheet table populating prebuilt function outputting at least one first and at least one second data field or cell range, collectively the at least one first and the at least one second field;
the spreadsheet table populating prebuilt function receiving at least one fill parameter that specifies values to be filled including one first data field argument and at least one second field argument, wherein those arguments:
create fill sets that are user specified or an application default set of values for each of the first and second data fields/ranges,
cross joins the first field fill set and second field fill set values to create a combination fill set; and
the combination fill set including one or more combinations of the first and second field values that are not otherwise present in the unfilled spreadsheet table populating prebuilt function output; and
outputting the not otherwise present values from the combination fill set as part of its table output.

2. The method of claim 1, wherein the spreadsheet table populating prebuilt function is a spreadsheet table generating prebuilt function.

3. The method of claim 1, wherein the spreadsheet table populating prebuilt function is a spreadsheet table transforming prebuilt function.

4. The method of claim 1, further including table outputs other than the first and second data fields that are filled with blank, null or empty values for the fill added combinations of first and second data fields.

5. The method of claim 1, wherein the at least one second data field includes two or more second data fields in the fill parameter so that the cross join filled combination is for the first data field and the two or more second data fields.

6. The method of claim 1, wherein the fill parameter positioned in an argument list as an optional argument to the prebuilt spreadsheet table populating function.

7. The method of claim 1, wherein the fill parameter is identified by a keyword named argument as an optional argument to the prebuilt spreadsheet table populating function.

8. The method of claim 1, wherein the fill parameter is positioned as a modifier of the first data field or second data field argument.

9. The method of claim 1, wherein the fill parameter is a prebuilt function with arguments of the first and second fields and their respective fill set specifiers.

10. The method of claim 1, wherein the fill parameter argument has separate arguments for each first and second field and their respective fill set specifiers.

11. The method of claim 1, wherein the fill parameter argument has separate arguments for each first and second field and any non-default fill set specifiers are field one or field two arguments.

12. The method of claim 1, wherein the fill set of values is a complete set of values for the field with any duplicate data set values for that data field.

13. The method of claim 1, wherein the fill set of values is a set of unique data set values, without duplicates, for that data field.

14. The method of claim 1, wherein the default fill set of values is the unique set of data set values for that data field.

15. The method of claim 1, wherein the data set values used in the fill set are subject to a value constraint or filter that selects a subset of the data set values.

16. The method of claim 1, wherein the specified set of fill values is a range of dates or integers that automatically increments by one day or one integer value between the specified end points of the range.

17. The method of claim 1, wherein the user specified set of fill values is a list specified by the user.

18. The method of claim 1, wherein the specified set of fill values is specified by a cell or cell range reference.

19. The method of claim 1, wherein the first or second data field is a date or integer data type.

20. The method of claim 1, wherein the first or second data field is a real or text data type.

21. The method of claim 1, wherein the table populating function has more than one fill parameter.

22. The method of claim 21, wherein a first and second fill parameters share no common fields.

23. The method of claim 21, wherein a first fill parameter uses a particular data field as a first field and a second fill parameter uses the particular data field as a second field.

24. The method of claim 1, wherein the filling is done before any sorting is done by the prebuilt spreadsheet table function.

25. The method of claim 1, wherein the filling does not alter any of the calculations done by the prebuilt spreadsheet table function.
